(19) United States
(12) Patent Application Publication
(10) Pub. No.: US 2025/0133593 A1
(43) Pub. Date: Apr. 24, 2025

(54) EXCHANGING REQUEST-TO-SEND (RTS) AND CLEAR-TO-SEND (CTS) FRAMES FOR PROTECTING RELAY OPERATIONS IN WIRELESS NETWORKS

(71) Applicant: NEWRACOM, Inc., Irvine, CA (US)

(72) Inventors: Yeon-Geun LIM, Seoul (KR); Si-Chan NOH, Seoul (KR); Joonsoo LEE, Seoul (KR)

(73) Assignee: NEWRACOM, Inc., Irvine, CA (US)

(21) Appl. No.: 18/912,512

(22) Filed: Oct. 10, 2024

Related U.S. Application Data
(60) Provisional application No. 63/592,704, filed on Oct. 24, 2023.

(51) Int. Cl. H04W 74/0816; H04W 84/12; H04W 88/04

(52) U.S. Cl. CPC H04W 74/0816; H04W 84/12; H04W 88/04

(57) ABSTRACT

An embodiment is method performed by a source node to transmit data to a destination node via a relay node. The method includes transmitting a first multi-user request-to-send (MU RTS) frame to the relay node, receiving a first clear-to-send (CTS) frame corresponding to the first MU RTS frame from the relay node, upon receiving the first CTS frame from the relay node, waiting for a first length of time that allows the relay node to transmit a second MU RTS frame to the destination node and receive a second CTS frame corresponding to the second MU RTS frame from the destination node, and after waiting for the first length of time, transmitting a data frame to the relay node that is to be relayed by the relay node to the destination node.

### CROSS-REFERENCE TO RELATED APPLICATION

This application claims the benefit of U.S. Provisional Application No. 63/592,704 filed Oct. 24, 2023, which is hereby incorporated by reference.

### TECHNICAL FIELD

The present disclosure generally relates to wireless communications, and more specifically, relates to request-to-send (RTS) frame and clear-to-send (CTS) frame exchange sequences for protecting relay operations in wireless networks in a wireless network.

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHZ, 6 GHZ, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

IEEE 802.11be, also known as “Wi-Fi 7”, is the next generation of the IEEE 802.11 family of standards for wireless local area networks. Currently under development, 802.11be aims to significantly improve upon the capabilities of its predecessor, 802.11ax/Wi-Fi 6, by offering even higher data rates, lower latency, and increased reliability. The standard is expected to leverage advanced technologies such as multi-link operation (MLO), which allows devices to simultaneously use multiple frequency bands and channels for enhanced performance and reliability. Additionally, 802.11be will introduce 4096-QAM (Quadrature Amplitude Modulation), enabling higher data rates by encoding more bits per symbol. The standard will also feature improved medium access control (MAC) efficiency, enhanced power saving capabilities, and better support for high-density environments. With these advancements, 802.11be is expected to deliver theoretical maximum data rates of up to 46 gigabits per second (Gbps), making it suitable for bandwidth-intensive applications such as virtual and augmented reality, 8K video streaming, and high-performance gaming. The IEEE 802.11be standard is projected to be finalized by the end of 2024, paving the way for the next generation of Wi-Fi devices and networks.

The scope of future wireless networking standards (e.g., beyond IEEE 802.11be) includes technologies for rate-vs-range throughput improvements. One such technology is relay technology in which a relay node relays data transmitted by a source node to a destination node. There are two types of relay mechanisms. The first is a decode-and-forward (DF) relay mechanism and the second is an amplify-and-forward (AF) relay mechanism. With the DF relay mechanism, a relay node decodes, re-encodes, and forwards the received signal to the destination node. With the AF relay mechanism, a relay node amplifies and retransmits the received signal to the destination node without decoding the signal. The AF relay mechanisms has at least the following benefits compared to the DF relay mechanism: lower computational cost and lower latency for data exchange.

In an AF relay system, the legacy request-to-send (RTS) frame and clear-to-send (CTS) frame exchange directly passing through the AF relay node can protect the forwarded data. However, this legacy RTS frame and CTS frame exchange-based protection mechanism requires that the AF relay node always have its relay functionality turned on, even when there is no data to be relayed. The relay functionality of the AF relay always being turned on may result in at least the following issues: unexpected noise and interference can be amplified and forwarded by the relay node, even when there is no data to be relayed to a destination node; and power of the relay node can be wasted. To solve this problem, a technique has been proposed where a relay node keeps its relay functionality turned off by default and only turns on its relay functionality when it receives a frame indicating that the relay node should turn on its relay functionality. The frame may include relay control information for controlling the relay operation of the relay node. The frame may be a trigger frame, a multi-user request-to-send (MU RTS) frame, a MU RTS transmission opportunity sharing (MU RTS TXS) frame, or other type of control frame.

In a relay system, RTS and CTS frames may be exchanged between a source node, a relay node, and a destination node to protect the relay operation. However, the existing protection mechanism has at least the following issues:

Issue 1: In a DF relay system, the resources used by the source node to transmit the data and the resources used by the source node to wait for the forwarded ACK can be wasted if the RTS frame and CTS frame exchange between the relay node and the destination node fails.

Issue 2: In a DF relay system, the existing protection mechanism cannot protect downlink orthogonal frequency division multiple access (DL OFDMA) or uplink orthogonal frequency division multiple access (UL-OFDMA) physical layer protocol data unit (PPDU) transmissions, which have been supported since the IEEE 802.11ax wireless networking standard.

Issue 3: In DF and AF relay systems, the MAC overhead caused by RTS frame and CTS frame exchanges can be high compared to situations where a source node and a destination communicate directly with each other without going through a relay node.

Issue 4: In an AF relay system, if the minimum time duration for the relay node to turn on its relay functionality is longer than the time duration between the end of the frame that includes the relay on/off indicator and the end of the corresponding response frame plus a short interframe space (SIFS), the relay node cannot begin relaying frames immediately after the SIFS interval that follows the response frame.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing data being relayed using a decode-and-forward (DF) relay mechanism, according to some embodiments.

FIG. 11 is a diagram showing an example of data being relayed using an amplify-and-forward (AF) relay mechanism, according to some embodiments.

FIG. 12 is a diagram showing a frame exchange sequence in which a source node transmits a multi-user request-to-send transmission opportunity sharing (MU RTS TXS) frame to a DF relay node to initiate relay operations, according to some embodiments.

FIG. 13 is a diagram showing a frame exchange sequence in which a source node transmits a MU RTS TXS frame to an AF relay node to turn on relay functionality of the AF relay node, according to some embodiments.

FIG. 14 is a diagram showing a frame exchange sequence based on Technique 1 Method 1, according to some embodiments.

FIG. 15 is a diagram showing a frame exchange sequence based on Technique 1 Method 1 when the second request-to-send (RTS) frame and clear-to-send (CTS) frame exchange fails, according to some embodiments.

FIG. 16 is a diagram showing a frame exchange sequence based on Technique 1 Method 2, according to some embodiments.

FIG. 17 is a diagram showing a frame exchange sequence based on Technique 1 Method 2 when the second RTS frame and CTS frame exchange fails and the CTS-to-self frame is not transmitted, according to some embodiments.

FIG. 18 is a diagram showing a frame exchange sequence based on Technique 1 Method 3, according to some embodiments.

FIG. 19 is a diagram showing a frame exchange sequence based on Technique 1 Method 3 when the second RTS frame and CTS frame exchange fails, according to some embodiments.

FIG. 20 is a diagram showing a frame exchange sequence based on Technique 1 Method 4, according to some embodiments.

FIG. 21 is a diagram showing a frame exchange sequence based on Technique 1 Method 3 when the second RTS frame and CTS frame exchange fails, according to some embodiments.

FIG. 22 is a diagram showing a frame exchange sequence based on Technique 2 Method 1, according to some embodiments.

FIG. 23 is a diagram showing a frame exchange sequence based on Technique 2 Method 2 when the source node knows that the AF relay node's capability is Capa 1 or Capa 2, according to some embodiments.

FIG. 24 is a diagram showing a frame exchange sequence based on Technique 2 Method 2 when the source node knows that the AF relay node's capability is Capa 3, according to some embodiments.

FIG. 25 is a diagram showing a frame exchange sequence based on Technique 2 Method 3, according to some embodiments.

FIG. 26 is a diagram showing a method performed by a relay node to determine whether a received MU RTS (TXS) frame triggers transmission of a MU RTS2 (TXS) frame based on Technique 3 Method 1, according to some embodiments.

FIG. 27 is a diagram showing a method performed by a relay node to encode a MU RTS2 (TXS) frame based on Technique 3 Method 1, according to some embodiments.

FIG. 28 is a diagram showing a method performed by a relay node to determine whether a received MU RTS (TXS) frame triggers transmission of a MU RTS2 (TXS) frame based on Technique 3 Method 2, according to some embodiments.

FIG. 29 is a diagram showing a method performed by a relay node to determine whether a received MU RTS (TXS) frame triggers transmission of a MU RTS2 (TXS) frame based on Technique 3 Method 3, according to some embodiments.

FIG. 30 is a diagram showing a method performed by a relay node to determine whether a received MU RTS (TXS) frame triggers transmission of a MU RTS2 frame based on Technique 3 Method 4, according to some embodiments.

FIG. 31 is a flowchart of a method for a source node to transmit data to a destination node via a relay node based on Technique 1 Method 1, according to some embodiments.

FIG. 32 is a flowchart of a method for a relay node to relay data transmitted by a source node to a destination node based on Technique 1 Method 1, according to some embodiments.

FIG. 33 is a flowchart of a method for a source node to transmit data to a destination node via a relay node based on Technique 1 Method 2, according to some embodiments.

FIG. 34 is a flowchart of a method for a relay node to relay data transmitted by a source node to a destination node based on Technique 1 Method 2, according to some embodiments.

FIG. 35 is a flowchart of a method for a source node to transmit data to a destination node via a relay node based on Technique 1 Method 3, according to some embodiments.

FIG. 36 is a flowchart of a method for a relay node to relay data transmitted by a source node to a destination node based on Technique 1 Method 3, according to some embodiments.

FIG. 37 is a flowchart of a method for a source node to transmit data to a destination node via a relay node based on Technique 1 Method 4, according to some embodiments.

FIG. 38 is a flowchart of a method for a relay node to relay data transmitted by a source node to a destination node based on Technique 1 Method 4, according to some embodiments.

### DETAILED DESCRIPTION

The present disclosure generally relates to wireless communications, and more specifically, relates to request-to-send (RTS) frame and clear-to-send (CTS) frame exchange sequences for protecting relay operations in wireless networks.

Techniques for exchanging RTS frames and CTS frames for protecting relay operations in a wireless network are described herein. The techniques described herein may address one or more of the issues mentioned above that affect existing protection mechanisms, thereby improving the rate-vs-range performance of wireless devices that communicate via a relay node. A first technique described herein is a RTS frame and CTS frame exchange sequence in a decode-and-forward (DF) relay system. A second technique described herein is a RTS frame and CTS frame exchange sequence in an amplify-and-forward (AF) relay system. A third technique described here is an encoding mechanism for a RTS frame.

The techniques described herein may address one or more of the issues mentioned above. While certain advantages are mentioned herein, one of ordinary skill in the relevant art will appreciate that the techniques disclosed herein may provide other advantages in view of the present disclosure.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

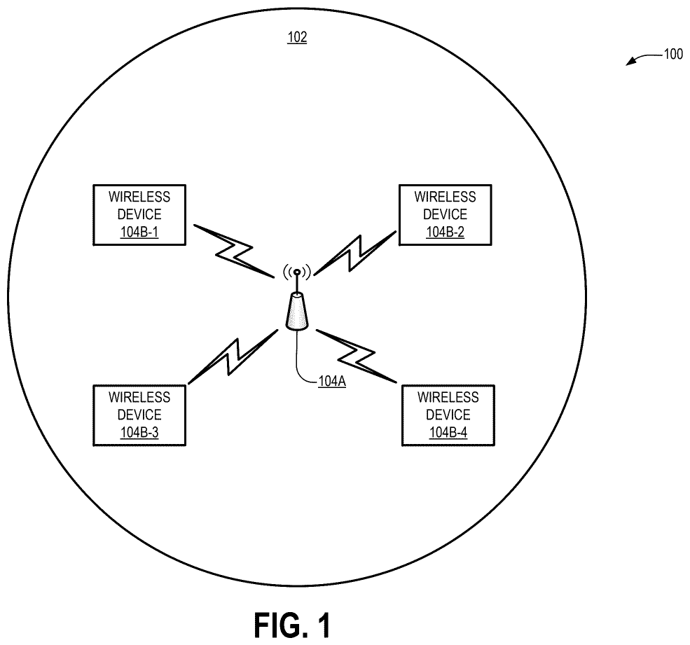

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B1-104B4 that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B1-104B4) may be collectively referred to as STAs. However, for ease of description, only the non-AP STAs may be referred to as STAs unless the context indicates otherwise. Although shown with four non-AP STAs (e.g., the wireless devices 104B1-104B4), the WLAN 100 may include any number of non-AP STAs (e.g., one or more wireless devices 104B).

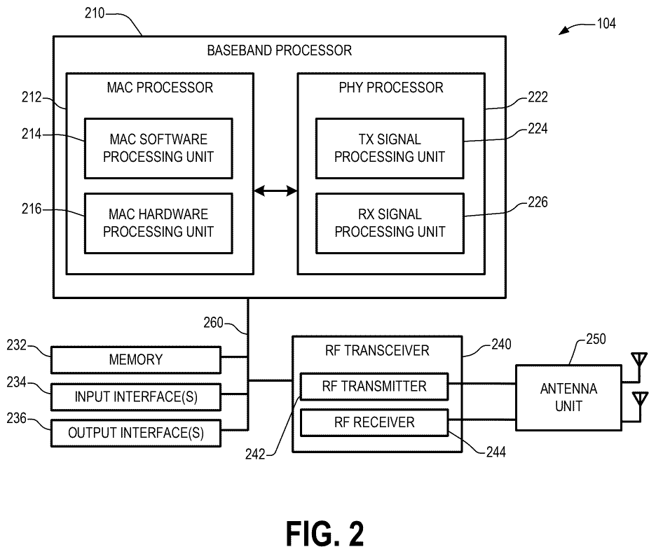

FIG. 2 illustrates a schematic block diagram of a wireless device 104, according to an embodiment. The wireless device 104 may be the wireless device 104A (i.e., the AP of the WLAN 100) or any of the wireless devices 104B1-104B4 in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

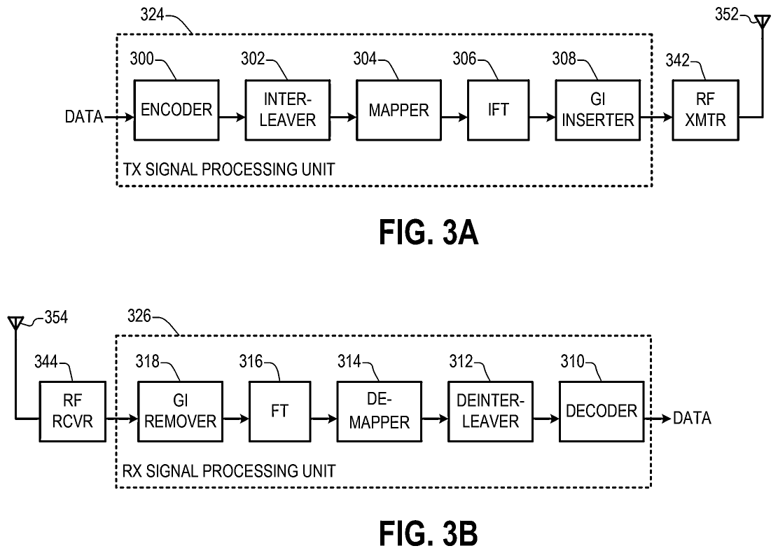

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0s or 1s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

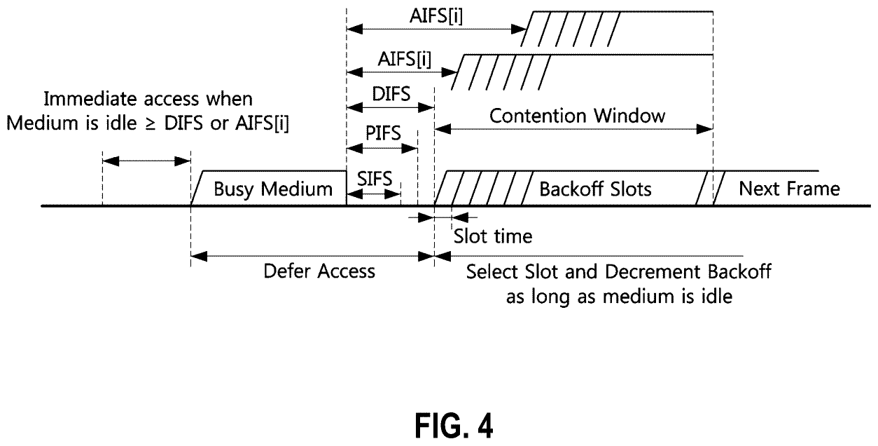

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QOS) functionality (that is, a QOS STA) may transmit the frame after performing backoff if an AIFS for an associated access category (AC) (i.e., AIFS[AC]) has elapsed. When transmitted by the QOS STA, any of the data frame, the management frame, and the control frame, which is not the response frame, may use the AIFS[AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

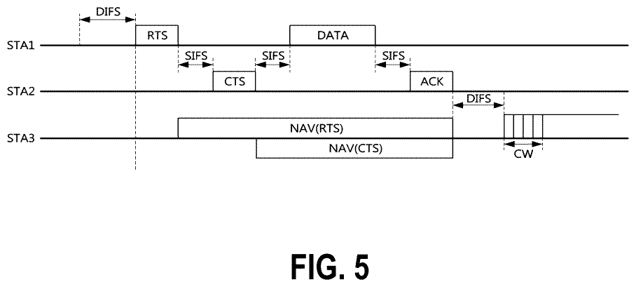

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

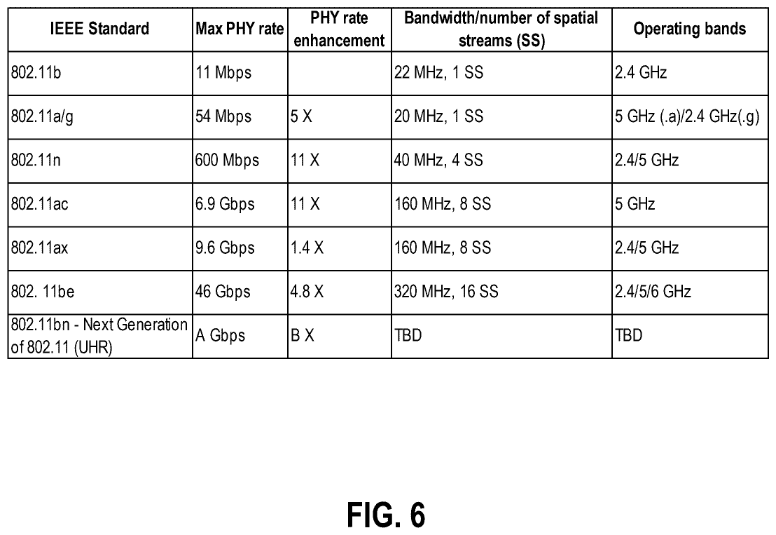

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHz), aggregated PPDU (A-PPDU), enhanced multi-link single-radio (eMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHZ) for IEEE 802.11be, more than 1 GHz of additional unlicensed spectrum is likely to be available because the 6 GHz band (5.925-7.125 GHz) is being considered for unlicensed use. This would allow APs and STAs to become tri-band devices. Larger than 160 MHz data transmissions (e.g., 320 MHz or 640 MHz) could be considered to increase the maximum PHY rate. For example, 320 MHz or 160+160 MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

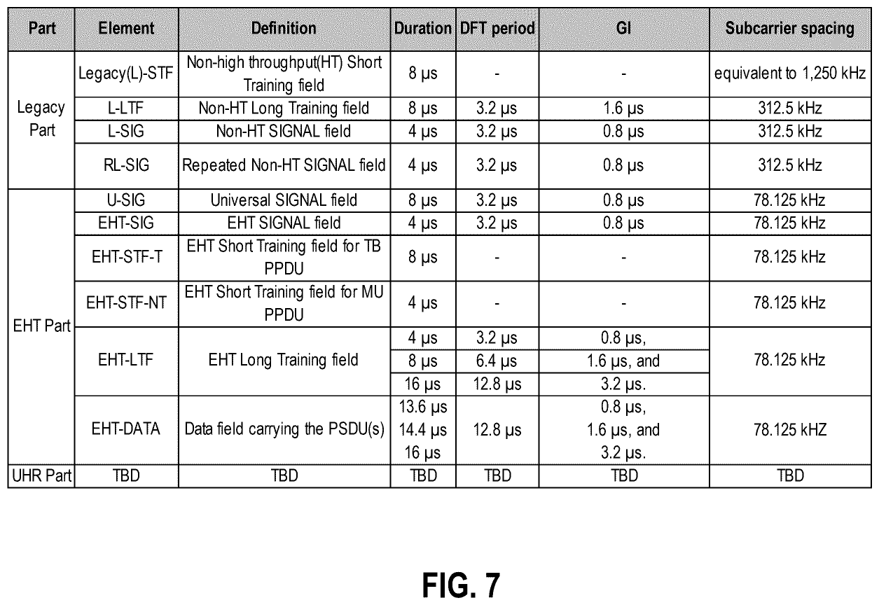

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

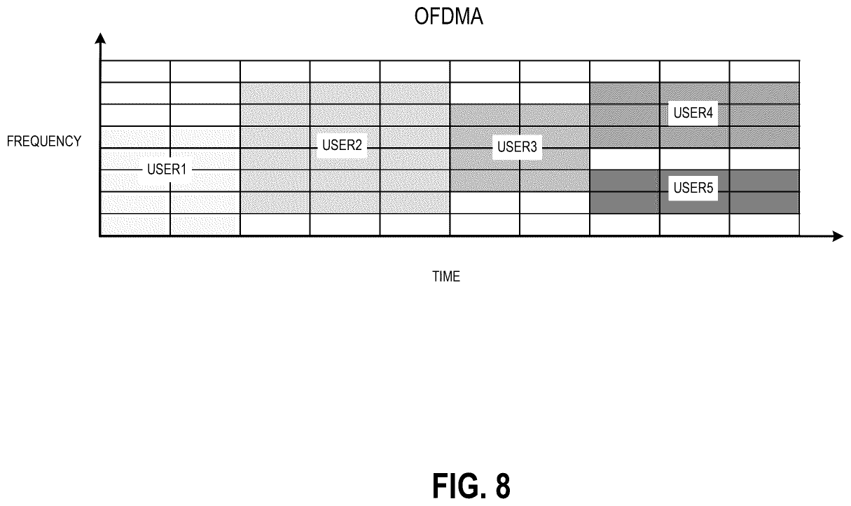

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

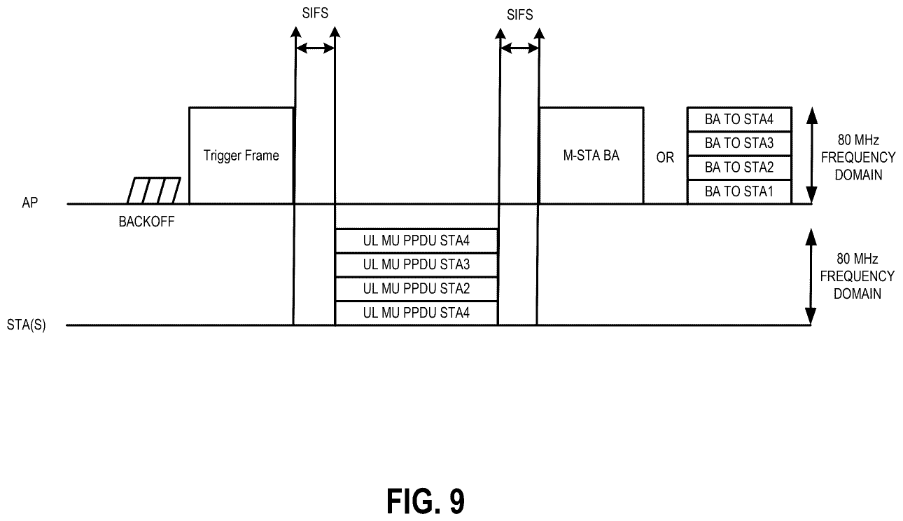

FIG. 9 illustrates an example scenario where an access point (AP) operating in an 80 MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80 MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (C-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:

Coordinated Beamforming (C-BF): Multiple APs transmit on the same frequency resource by coordinating and forming spatial nulls, allowing for simultaneous transmission from multiple APs.

Coordinated OFDMA (C-OFDMA): APs transmit on orthogonal frequency resources by coordinating and splitting the spectrum, enabling more efficient spectrum utilization.

Joint Transmission (JTX): Multiple APs transmit jointly to a given user simultaneously by sharing data between the APs.

Coordinated Spatial Reuse (C-SR): Multiple APs or STAs adjust their transmit power to reduce interference between APs.

By implementing these AP coordination schemes, WLAN systems can improve their overall throughput and efficiency by leveraging the cooperation between multiple APs.

The use of relay communication can increase the flexibility of wireless network deployments. Relay communication is one of the technologies that is being considered for use in future wireless networking standards (e.g., IEEE 802.11 UHR (IEEE 802.11bn)) to help improve rate-vs-range throughput. For example, by using relay communication, a first wireless device that is outside of the communication range of a second wireless device can communicate with the second wireless device via a relay device. Also, using relay communication can boost the signal-to-noise ratio (SNR), which can help improve throughput. There are two types of relay mechanisms: the first is the decode-and-forward (DF) relay mechanism and the second is the amplify-and-forward (AF) relay mechanism.

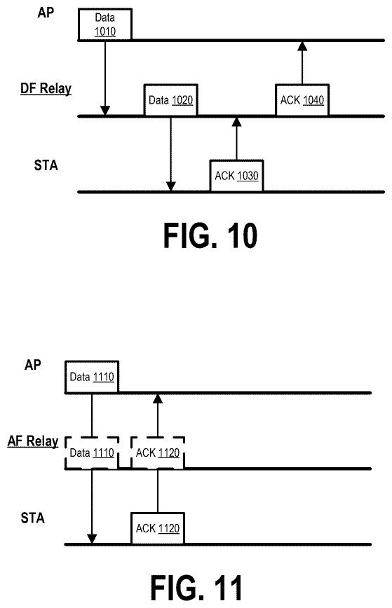

FIG. 10 is a diagram showing data being relayed using a DF relay mechanism, according to some embodiments.

As shown in the diagram, an AP may transmit data frame 1010 that is to be relayed to a STA by a DF relay node. As used herein, a DF relay node is a relay node that uses a DF relay mechanism for relaying data. The DF relay node may receive data frame 1010 that was transmitted by the AP and decode it. After decoding data frame 1010, the DF relay node may reencode data frame 1010 as relay data frame 1020 and transmit relay data frame 1020 to the STA. If the STA successfully receives relay data frame 1020, it may respond by transmitting acknowledgement (ACK) frame 1030. The DF relay node may receive ACK frame 1030 that was transmitted by the STA and decode it. After decoding ACK frame 1030, the STA may reencode ACK frame 1030 as relay ACK frame 1040 and transmit relay ACK frame 1040 to the AP.

FIG. 11 is a diagram showing an example of data being relayed using an AF relay mechanism, according to some embodiments.

As shown in the diagram, an AP may transmit data frame 1110 that is to be relayed to a STA by an AF relay node. As used herein, an AF relay node is a relay node that uses an AF relay mechanism for relaying data. The AF relay node may amplify and forward data frame 1110 to the STA (as represented in the diagram by the AF relay node transmitting data frame 1110 in dashed lines). If the STA successfully receives amplified and forwarded data frame 1110, it may respond by transmitting an ACK frame 1120. The AF relay node may amplify and forward ACK frame 1120 to the AP (as represented in the diagram by the AF relay node transmitting ACK frame 1120 in dashed lines). The AF relay mechanism has at least the following benefits compared to the DF relay mechanism: lower computation cost (e.g., because there is no need to fully decode received frames) and lower latency for data exchange.

In a relay system, forwarded data should be protected, taking into consideration the hidden node problem caused by the extended transmission range of the relay node. Various transmission opportunity (TXOP) sharing procedures have been introduced to solve this problem in a DF relay scenario. For example, the IEEE 802.11ah wireless networking standard specifies TXOP sharing and protection procedures that use explicit/implicit acknowledgements (ACK). Also, the IEEE 802.11 Ultra High Reliability (UHR) study group (SG) has discussed a TXOP sharing for a DF relay node that re-uses a MU RTS TXS sequence.

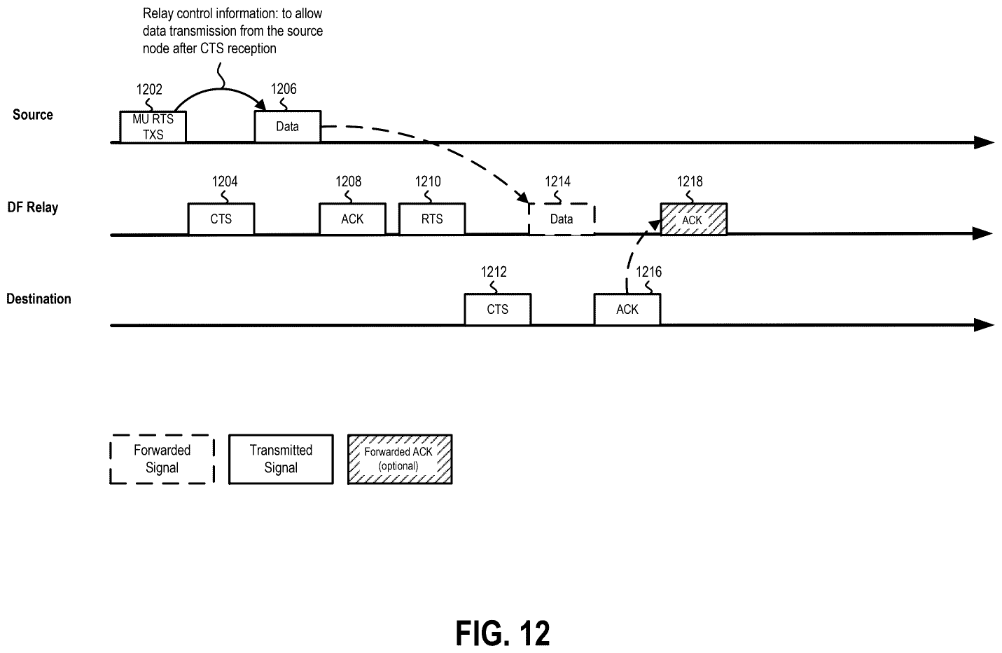

FIG. 12 is a diagram showing a frame exchange sequence in which a source node transmits a MU RTS TXS frame to a DF relay node to initiate relay operations, according to some embodiments.

As shown in the diagram, the source node may transmit MU RTS TXS frame 1202 to the DF relay node. MU RTS TXS frame 1202 may include relay control information for the relay node. The inclusion of the relay control information in MU RTS TXS frame 1202 may allow the source node to transmit data that is to be relayed to the destination node via the relay node after the source node receives CTS frame 1204 from the relay node. Responsive to receiving MU RTS TXS frame 1202, the relay node may transmit CTS frame 1204 to the source node. Responsive to receiving CTS frame 1204, the source node may transmit data frame 1206 to the relay node with the expectation that the relay node will relay data frame 1206 to the destination node. Data frame 1206 may include data that is intended for the destination node. Responsive to receiving data frame 1206, the source node may transmit acknowledgment (ACK) frame 1208 to the source node to acknowledge successful reception of data frame 1206. The relay node may then transmit RTS frame 1210 to the destination node. Responsive to receiving RTS frame 1210, the destination node may transmit CTS frame 1212 to the relay node. The exchange of RTS frame 1210 and CTS frame 1212 may help protect the transmission of upcoming relay data frame 1214. Responsive to receiving CTS frame 1212, the relay node may transmit relay data frame 1214 to the destination node. Relay data frame 1214 may include the same data that was included in data frame 1206 (data intended for the destination node) and decoded therefrom. Responsive to receiving relay data frame 1214, the destination node may transmit ACK frame 1216 to the relay node to acknowledge successful reception of relay data frame 1214. The relay node may optionally transmit relay ACK frame 1218 to the source node to indicate that data frame 1206 was successfully relayed to the destination node.

In an AF relay system, the legacy RTS frame and CTS frame exchange directly passing through the AF relay node can protect the relayed data. However, this legacy RTS frame and CTS frame exchange-based protection mechanism requires that the AF relay node always have its relay functionality turned on, even when there is no data to be relayed. The relay functionality of the AF relay node always being turned on may result in at least the following issues: unexpected noise and interference can be amplified and forwarded by the relay node, even when there is no data to be relayed to a destination node; and power of the relay node can be wasted.

To address this problem, a technique has been proposed where a relay node keeps its relay functionality turned off by default and only turns on its relay functionality when it receives a frame indicating that the relay node should turn on its relay functionality. The frame may include relay control information for controlling the relay operation of the relay node. The frame may be a trigger frame, a MU RTS frame, a MU RTS TXS frame, or other type of control frame.

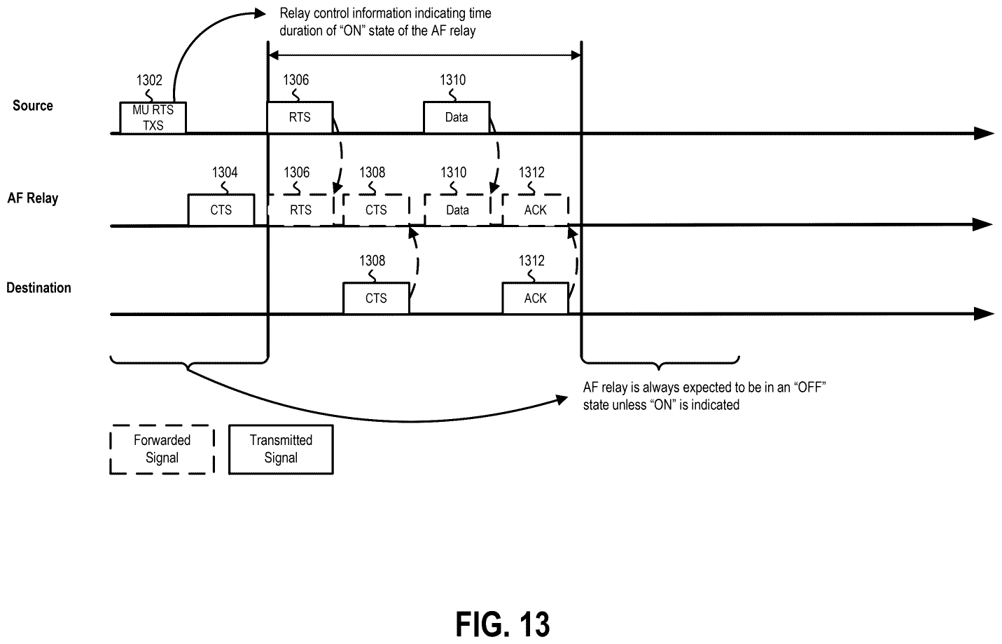

FIG. 13 is a diagram showing a frame exchange sequence in which a source node transmits a MU RTS TXS frame to an AF relay node to turn on relay functionality of the AF relay node, according to some embodiments.

The AF relay node is expected to keep its relay functionality turned off by default and only turn on its relay functionality when requested. As shown in the diagram, the source node may transmit MU RTS TXS frame 1302 to the relay node to indicate that the relay node should turn on its relay functionality. MU RTS TXS frame 1302 may include relay control information for the relay node such as information regarding how long the relay node should keep its relay functionality turned on (i.e., how long the relay node should stay in the “ON” state). Responsive to receiving MU RTS TXS frame 1302, the relay node may transmit CTS frame 1304 to the source node and then turn on its relay functionality. Responsive to receiving CTS frame 1304, the source node may transmit RTS frame 1306 and the AF relay node may relay RTS frame 1306 to the destination node (e.g., by amplifying and forwarding RTS frame 1306). Responsive to receiving RTS frame 1306, the destination node may transmit CTS frame 1308 and the AF relay node may relay CTS frame 1308 to the source node. The exchange of RTS frame 1306 and CTS frame 1308 may help protect the transmission of upcoming data frame 1310. Responsive to receiving CTS frame 1308, the source node may transmit data frame 1310 and the AF relay node may relay data frame 1310 to the destination node.

Responsive to receiving data frame 1310, the destination node may transmit ACK frame 1312 to acknowledge successful reception of data frame 1310. The AF relay node may relay ACK frame 1312 to the source node. The AF relay node may turn off its relay functionality (be in the “OFF” state) after the time duration indicated by the relay control information included in MU RTS TXS frame 1302 expires.

However, the existing protection mechanisms have at least the following issues:

Issue 1: In a DF relay system, the resources used by the source node to transmit the data and the resources used by the source node to wait for the forwarded ACK can be wasted if the RTS frame and CTS frame exchange between the relay node and the destination node fails. For example, in the frame exchange sequence shown in FIG. 12, the source node must wait to receive relay ACK frame 1218 to determine whether the data frame was successfully relayed to the destination node, which the relay node might not end up transmitting.

Issue 2: In a DF relay system, the existing protection mechanism cannot protect downlink orthogonal frequency division multiple access (DL OFDMA) or uplink orthogonal frequency division multiple access (UL-OFDMA) physical layer protocol data unit (PPDU) transmissions, which have been supported since the IEEE 802.11ax wireless networking standard. For example, in the frame exchange sequence shown in FIG. 12, the source node cannot transmit data frame 1206 as part of a DL OFDMA PPDU and RTS frame 1210 cannot be a MU RTS frame.

Issue 3: In DF and AF relay systems, the MAC overhead caused by RTS frame and CTS frame exchanges can be high compared to situations where a source node and a destination communicate directly with each other without going through a relay node. For example, the frame exchange sequences shown in FIGS. 12 and 13 require transmitting at least double the number of frames compared to a frame exchange sequence that does not involve a relay operation (e.g., four frames vs. two frames).

Issue 4: In an AF relay system, if the minimum time duration for the relay node to turn on its relay functionality is longer than the time duration between the end of the frame that includes the relay on/off indicator and the end of the corresponding response frame plus a short interframe space (SIFS), the relay node cannot begin relaying frames immediately after the SIFS interval that follows the response frame. For example, in the frame exchange sequence shown in FIG. 13, if the minimum time duration it takes for the relay node to turn on its relay functionality is longer than the time duration between the end of MU RTS TXS frame 1302 and the end of CTS frame 1304 plus SIFS, the relay node cannot relay RTS frame 1306 immediately after transmitting CTS frame 1304 (e.g., SIFS interval following transmission of CTS frame 1304).

Techniques for exchanging RTS and CTS frames for protecting relay operations in a wireless network are described herein. The techniques described herein may address one or more of the issues mentioned above that affect existing protection mechanisms, thereby improving the rate-vs-range performance of wireless devices that communicate via a relay node.

Relay functionality that is turned on may also be referred to as the relay functionality being activated or similar terminology. A relay node that has its relay functionality turned on may be referred to as being in an “ON” state. Relay functionality that is turned off may also be referred to as the relay functionality being deactivated or similar terminology. A relay node that has its relay functionality turned off may be referred to as being in an “OFF” state. A relay node that has its relay functionality turned on is capable of relaying data, whereas a relay node that has its relay functionality turned off is not capable of relaying data.

The techniques described herein may involve a relay node that decodes and forwards a MU RTS frame or a MU RTS TXS frame. A MU RTS frame and a MU RTS TXS frame may be considered as a type of RTS frame. The MU RTS frame and MU RTS TXS frame mentioned herein may be a variant of an existing MU RTS frame, an existing MU RTS TXS frame, or a trigger frame. As used herein, a MU RTS (TXS) frame may refer to a MU RTS frame or a MU RTS TXS frame.

### Technique 1—RTS Frame and CTS Frame Exchange Sequence in a DF Relay System

With regard to Technique 1, various ways to exchange RTS frames and CTS frames in a DF relay system are described herein. Various time offsets for use with the new RTS frame and CTS frame exchange sequences can be defined. It is noted that the existing MU RTS (TXS) frame (e.g., MU RTS frame or MU RTS TXS frame defined in IEEE 802.11be) can be extended and/or reused/repurposed to include control information for controlling relay functionality of a DF relay node or an AF relay node. Such MU RTS (TXS) frame may be referred to herein as a MU RTS1 (TXS) frame.

To address Issue 1 mentioned above, the second RTS frame and CTS frame exchange between the relay node and the destination node may be performed before the source node transmit a data frame. To address Issue 2 mentioned above, a MU RTS (TXS) frame may be used in the second RTS frame and CTS frame exchange. A relay node may decode a MU RTS1 (TXS) frame and relay it to a destination node. The relayed MU RTS1 (TXS) frame may be referred to herein as a MU RTS2 (TXS) frame. The MU RTS2 (TXS) frame may be encoded with information that is obtained from decoding a MU RTS1 (TXS) frame and/or that is obtained from some other management frame, control frame, and so on. Details of how to encode a MU RTS1 (TXS) frame and a MU RTS2 (TXS) frame will be provided later herein with regard to Technique 3. To address Issue 3 mentioned above, a MU RTS2 (TXS) frame may be used as an implicit CTS frame.

### Technique 1 Method 1—Decoding and Relaying of a MU RTS (TXS) Frame are Performed in the Second RTS Frame and CTS Frame Exchange Before the Source Node Transmits a Data Frame

In an embodiment (referred to herein as “Technique 1 Method 1”), as will be described in additional detail herein, decoding and relaying of a MU RTS (TXS) frame are performed in the second RTS frame and CTS frame exchange before the source node transmits a data frame.

One or more of following time offsets to be used by the source node can be defined.

T1: A time offset between the end of the PPDU that carries a CTS frame corresponding to the MU RTS1 (TXS) frame and the start of the PPDU that carries the data frame. The time offset may be calculated by summing the estimated time duration of a RTS/MU RTS2 (TXS) frame, the estimated time duration of a CTS frame corresponding to the RTS/MU RTS2 (TXS) frame, and 3*aSIFSTime (where aSIFSTime is the time duration of a SIFS interval). If the source node receives the CTS frame corresponding to the MU RTS1 (TXS) frame, T1 may start at the end of the PPDU that carries the CTS frame.

T2: A time offset between the end of the PPDU that carries a RTS/MU RTS2 (TXS) frame and the start of the PPDU that carries the data frame. The time offset may be calculated by summing the estimated time duration of a CTS frame corresponding to the RTS/MU RTS2 (TXS) frame and 2*aSIFSTime. If the source node receives the RTS/MU RTS2 (TXS) frame, T2 may start at the end of the PPDU that carries the RTS/MU RTS2 (TXS) frame or the end of the time duration indicated by the PPDU that carries the RTS/MU RTS2 (TXS) frame.

T3: A time offset between the end of the PPDU that carries an ACK frame corresponding to the data frame and the start of the PPDU that carries the forwarded ACK frame. The time offset may be calculated by summing the estimated time duration of the relayed data frame, the time duration of an ACK frame corresponding to the relayed data frame, and 3*aSIFSTime. If the source node receives the ACK frame corresponding to the data frame, T3 may start at the end of the ACK frame.

T4: A time offset between the end of the PPDU that carries the relayed data frame and the start of the PPDU that carries the relayed ACK frame. The time offset may be calculated by summing the estimated time duration of an ACK frame corresponding to the relayed data frame and 2*aSIFSTime. If the source node receives the relayed data frame, T4 may start at the end of the PPDU that carries the relayed data frame or the end of the time duration indicated by the PPDU that carries the relayed data frame.

In Technique 1 Method 1, the data frame transmitted by the source node to the relay node may require an immediate response (e.g., in the form of an ACK frame).

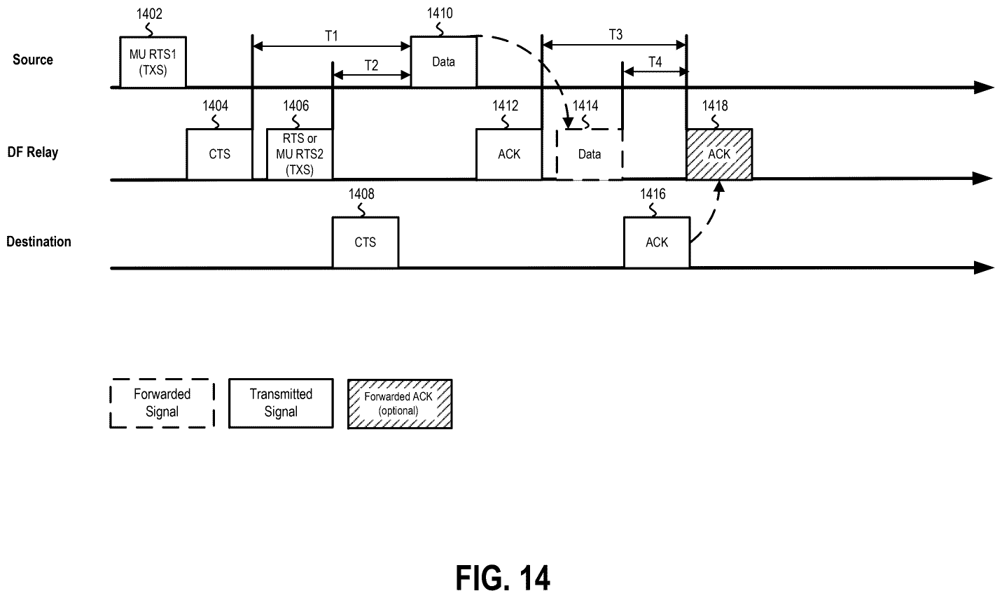

FIG. 14 is a diagram showing a frame exchange sequence based on Technique 1 Method 1, according to some embodiments.

As shown in the diagram, the source node may transmit MU RTS1 (TXS) frame 1402 to the relay node. Responsive to receiving MU RTS1 (TXS) frame 1402, the relay node may transmit CTS frame 1404 to the source node. The relay node may then transmit RTS frame or MU RTS2 (TXS) frame 1406 to the destination node. Responsive to receiving RTS or MU RTS2 (TXS) frame 1406, the destination node may transmit CTS frame 1408 to the relay node.

The source node may transmit data frame 1410 after T1 or T2 as shown in the diagram. The relay node may expect to receive data frame 1410 following a SIFS interval after the end of CTS frame 1408. Data frame 1410 may include data that is intended for the destination node.

Responsive to receiving data frame 1410, the relay node may transmit ACK frame 1412 to the source node to acknowledge successful reception of data frame 1410. If the source node receives ACK frame 1412, it may know that its data frame 1410 will be relayed to the destination node.

After transmitting ACK frame 1412, the relay node may relay data frame 1410 to the destination node by transmitting relay data frame 1414. Relay data frame 1414 may include the same data that was included in data frame 1410 and decoded therefrom. Responsive to receiving relay data frame 1414, the destination node may transmit ACK frame 1416 to the relay node to acknowledge successful reception of relay data frame 1414. Optionally, responsive to receiving ACK frame 1416, the relay node may relay ACK frame 1416 to the source node by transmitting relay ACK frame 1418. The source node may wait for T3 or T4 as shown in the diagram to receive relay ACK frame 1418.

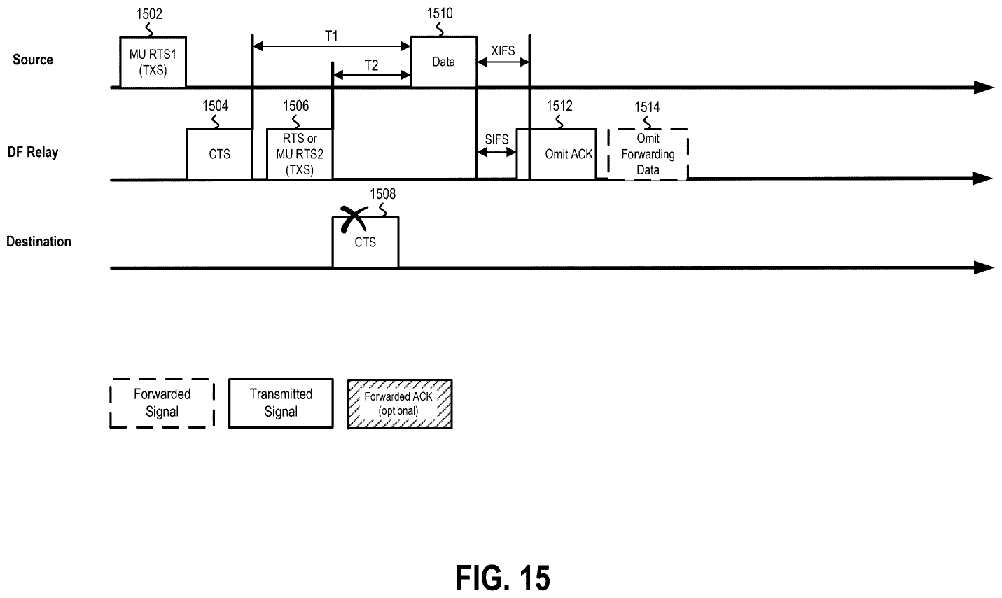

FIG. 15 is a diagram showing a frame exchange sequence based on Technique 1 Method 1 when the second RTS frame and CTS frame exchange fails, according to some embodiments.

As shown in the diagram, the source node may transmit MU RTS1 (TXS) frame 1502 to the relay node. Responsive to receiving MU RTS1 (TXS) frame 1502, the relay node may transmit CTS frame 1504 to the source node. The relay node may then transmit RTS frame or MU RTS2 (TXS) frame 1506 to the destination node but it is assumed in this example that the destination node does not successfully receive RTS or MU RTS2 (TXS) frame 1506 and thus the destination node does not transmit CTS frame 1508.

The source node may transmit data frame 1510 after T1 or T2 as shown in the diagram. The relay node may refrain from transmitting ACK frame 1512 corresponding to data frame 1510 to the source node (“Omit ACK”) even though the relay node successfully receives data frame 1510 because the relay node does not successfully receive CTS frame 1508 corresponding to RTS or MU RTS2 (TXS) frame 1506. Also, the relay node may refrain from relaying data frame 1510 (“Omit Forwarding Data” 1514). After a XIFS interval (where XIFS>SIFS) or after an ACK timeout from the end of data frame 1510, the source node may determine that its data frame 1510 will not be relayed to the destination node if it has not received an ACK frame corresponding to data frame 1510. In an embodiment, the source node does not wait for a relay ACK frame in this case (e.g., does not wait for T3 and T4). Also, the source node may not retransmit data frame 1510 after the XIFS interval or the ACK timeout.

### Technique 1 Method 2—Decoding and Relaying of a MU RTS (TXS) Frame and Transmission of a CTS-to-Self Frame are Performed in the Second RTS Frame and CTS Frame Exchange Before the Source Node Transmits a Data Frame

In an embodiment (referred to herein as “Technique 1 Method 2”), as will be described in additional detail herein, decoding and relaying of a MU RTS (TXS) frame and transmission of a CTS-to-self frame are performed in the second RTS frame and CTS frame exchange before the source node transmits a data frame.

One or more of following time offsets to be used by the source node can be defined.

T1: A time offset between the end of the PPDU that carries a CTS frame corresponding to the MU RTS1 (TXS) frame and the start of the PPDU that carries a CTS-to-self frame. The time offset may be calculated by summing the estimated time duration of a RTS/MU RTS2 (TXS) frame, the estimated time duration of a CTS frame corresponding to the RTS/MU RTS2 (TXS) frame, and 3*aSIFSTime. If the source node receives the CTS frame corresponding to the MU RTS1 (TXS) frame, T1 may start at the end of the PPDU that carries the CTS frame.

T2: A time offset between the end of the PPDU that carries a RTS/MU RTS2 (TXS) frame and the start of the PPDU that carries a CTS-to-self frame. The time offset may be calculated by summing the estimated time duration of a CTS frame corresponding to the RTS/MU RTS2 (TXS) frame and 2*aSIFSTime. If the source node receives the RTS/MU RTS2 (TXS) frame, T2 may start at the end of the PPDU that carries the RTS/MU RTS2 (TXS) frame or the end of the time duration indicated by the PPDU that carries the RTS/MU RTS2 (TXS) frame.

T3: This time offset is the same as T3 mentioned above with regard to Technique 1 Method 1, and is not described here again for the sake of conciseness.

T4: This time offset is the same as T4 mentioned above with regard to Technique 1 Method 1, and is not described here again for the sake of conciseness.

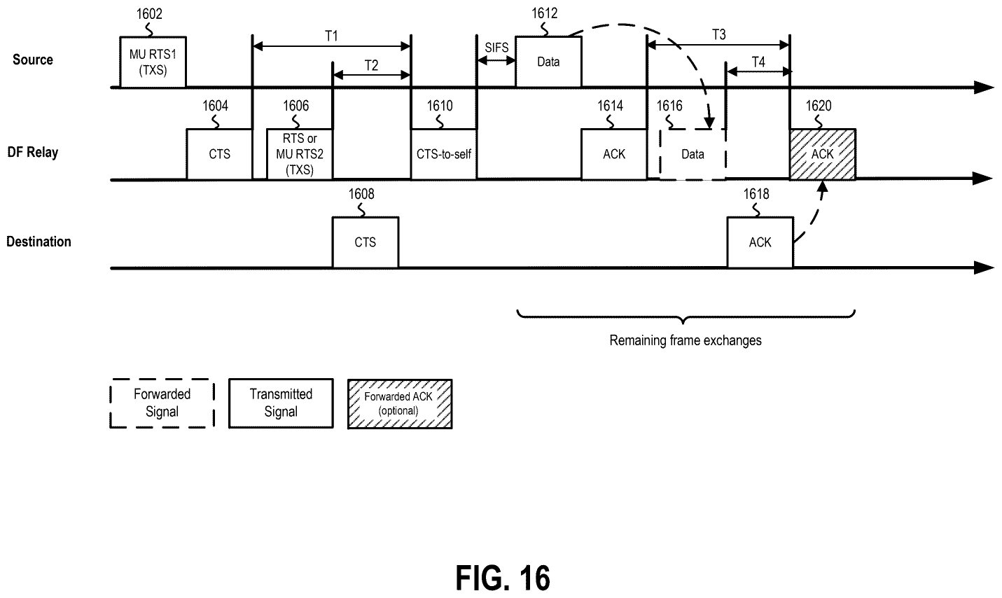

FIG. 16 is a diagram showing a frame exchange sequence based on Technique 1 Method 2, according to some embodiments.

As shown in the diagram, the source node may transmit MU RTS1 (TXS) frame 1602 to the relay node. Responsive to receiving MU RTS1 (TXS) frame 1602, the relay node may transmit CTS frame 1604 to the source node. The relay node may then transmit RTS frame or MU RTS2 (TXS) frame 1606 to the destination node. Responsive to receiving RTS or MU RTS2 (TXS) frame 1606, the destination node may transmit CTS frame 1608 to the relay node.

Responsive to receiving CTS frame 1608, the relay node may transmit CTS-to-self frame 1610. The source node may expect to receive CTS-to-self frame 1610 after T1 or T2 as shown in the diagram. The source node may receive CTS-to-self frame 1610 but ignore the network allocation vector (NAV) set by CTS-to-self frame 1610 or not set a NAV that can be obtained from CTS-to-self frame 1610.

Responsive to receiving CTS-to-self frame 1610, the source node may transmit data frame 1612 to the relay node (following a SIFS interval after the end of CTS-to-self frame 1610).

The remainder of the frame exchange sequence may be similar to the frame exchange sequence shown in FIG. 14 starting from the transmission of ACK frame 1412. For example, responsive to receiving data frame 1612, the relay node may transmit ACK frame 1614 to the source node to acknowledge successful reception of data frame 1612. If the source node receives ACK frame 1614, it may know that its data frame 1612 will be relayed to the destination node.

After transmitting ACK frame 1614, the relay node may relay data frame 1612 to the destination node by transmitting relay data frame 1616. Relay data frame 1616 may include the same data that was included in data frame 1612 and decoded therefrom. Responsive to receiving relay data frame 1616, the destination node may transmit ACK frame 1618 to the relay node to acknowledge successful reception of relay data frame 1616. Optionally, responsive to receiving ACK frame 1618, the relay node may relay ACK frame 1618 to the source node by transmitting relay ACK frame 1620. The source node may wait for T3 or T4 as shown in the diagram to receive relay ACK frame 1620.

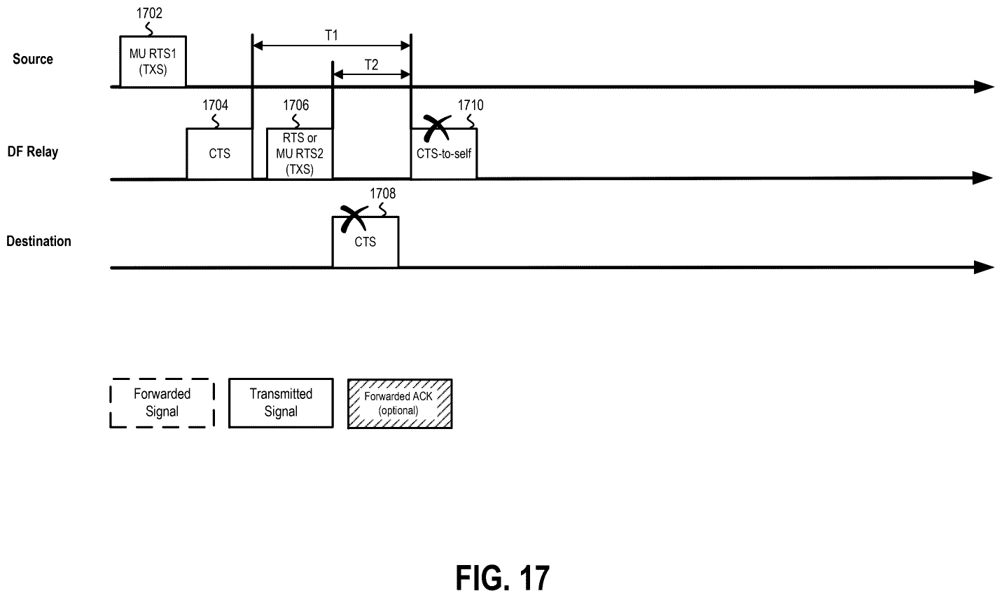

FIG. 17 is a diagram showing a frame exchange sequence based on Technique 1 Method 2 when the second RTS frame and CTS frame exchange fails and the CTS-to-self frame is not transmitted, according to some embodiments.

As shown in the diagram, the source node may transmit MU RTS1 (TXS) frame 1702 to the relay node. Responsive to receiving MU RTS1 (TXS) frame 1702, the relay node may transmit CTS frame 1704 to the source node. The relay node may then transmit RTS frame or MU RTS2 (TXS) frame 1706 to the destination node but it is assumed in this example that the destination node does not successfully receive RTS or MU RTS2 (TXS) frame 1706 and thus the destination node does not transmit CTS frame 1708.

The relay node may refrain from transmitting CTS-to-self frame 1710 if it does not receive CTS frame 1708 corresponding to RTS or MU RTS2 (TXS) frame 1706. Also, the source node may refrain from transmitting a data frame if it does not receive CTS-to-self frame 1710 from the relay node after T1 or T2 as shown in the diagram.

If the source node is an AP, it may follow the following procedure. The AP may wait for CTSTimeout interval of (aSIFSTime+aSlotTime+aRxPHYStartDelay) that begins after (T1-aSIFSTime) or (T2-aSIFSTime), where CTSTimeout interval is a CTS timeout interval, aSIFSTime is the time duration of a SIFS interval, aSlotTime is the time duration of a slot, and aRxPHYStartDelay is one or more integer delay values for each supported PHY clause, where each delay, in microseconds, is from the start of the PPDU at the receiver's antenna to the issuance of earlier of the PHYRXEARLYSIG.indication if sent or the PHY-RXSTART.indication primitive. If the MAC layer does not receive a PHY-RXSTART.indication primitive during the CTSTimeout interval, the AP may conclude that the transmission of the RTS/MU RTS2 (TXS) frame at the relay node has failed. The reception of a CTS-to-self frame from the relay node to which the MU RTS1 (TXS) frame was addressed before the PHY-RXEND.indication primitive may be interpreted as successful transmission of the RTS/MU RTS2 (TXS) frame to the non-AP STA (the destination node) from the relay node, permitting the frame exchange sequence to continue.

### Technique 1 Method 3—Transmission of Implicit CTS Frame is Performed in the Second RTS Frame and CTS Frame Exchange Before the Source Node Transmits a Data Frame

In an embodiment (referred to herein as “Technique 1 Method 3”), as will be described in additional detail herein, an implicit CTS frame is transmitted in the second RTS frame and CTS frame exchange before the source node transmits a data frame.

One or more of following time offsets to be used by the source node can be defined.

T2: A time offset between the end of the PPDU that carries an implicit CTS frame (e.g., MU RTS2 (TXS) frame) and the start of the PPDU that carries a data frame. The time offset may be calculated by summing the estimated time duration of a CTS frame corresponding to the MU RTS2 (TXS) frame and 2*aSIFSTime. If the source node receives the implicit CTS frame, T2 may start at the end of the PPDU that carries the implicit CTS frame.

T3: This time offset is the same as T3 mentioned above with regard to Technique 1 Method 1, and is not described here again for the sake of conciseness.

T4: This time offset is the same as T4 mentioned above with regard to Technique 1 Method 1, and is not described here again for the sake of conciseness.

In Technique 1 Method 3, the data frame transmitted by the source node to the relay node may require an immediate response (e.g., in the form of an ACK frame). Also, the MU RTS (TXS) frame decoded and forwarded by the relay node may be interpreted by the source node as an implicit CTS frame.

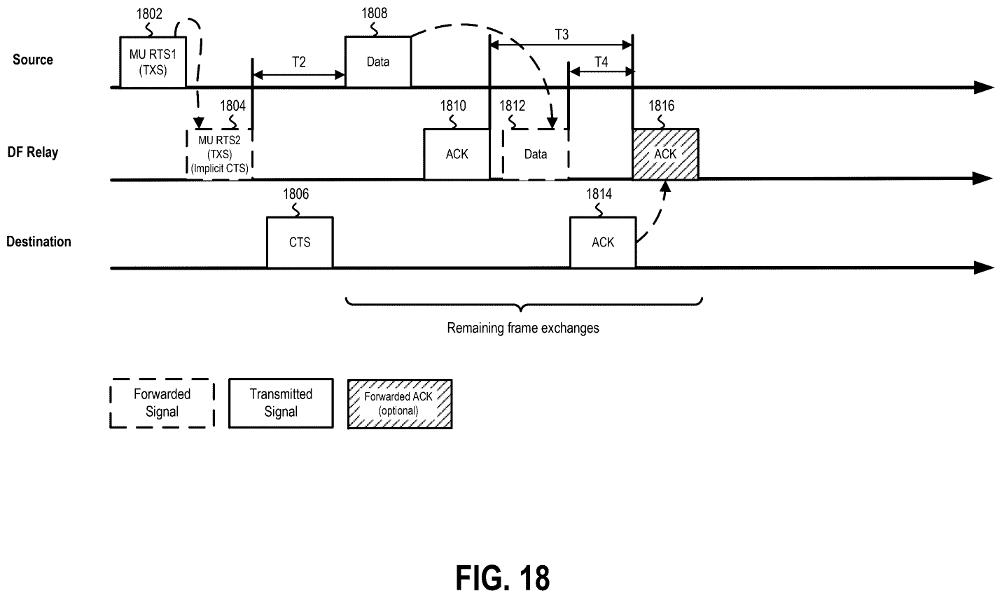

FIG. 18 is a diagram showing a frame exchange sequence based on Technique 1 Method 3, according to some embodiments.

As shown in the diagram, the source node may transmit MU RTS1 (TXS) frame 1802 to the relay node. Responsive to receiving MU RTS1 (TXS) frame 1802, the relay node may transmit MU RTS2 (TXS) frame 1804. MU RTS2 (TXS) frame 1804 may be interpreted by the source node as an implicit CTS frame (corresponding to MU RTS1 (TXS) frame 1802) and may be interpreted by the destination node as a MU RTS (TXS) frame. Responsive to receiving MU RTS2 (TXS) frame 1804, the destination node may transmit CTS frame 1806 to the relay node.

Responsive to receiving MU RTS2 (TXS) frame 1804 (an implicit CTS frame), the source node may transmit data frame 1808 after T2 as shown in the diagram. The relay node may expect to receive data frame 1808 after a SIFS interval following the end of CTS frame 1806.

The remainder of the frame exchange sequence may be similar to the frame exchange sequence shown in FIG. 14 starting from the transmission of ACK frame 1412. For example, responsive to receiving data frame 1808, the relay node may transmit ACK frame 1810 to the source node to acknowledge successful reception of data frame 1808. If the source node receives ACK frame 1810, it may know that its data frame 1808 will be relayed to the destination node.

After transmitting ACK frame 1810, the relay node may relay data frame 1808 to the destination node by transmitting relay data frame 1812. Relay data frame 1812 may include the same data that was included in data frame 1808 and decoded therefrom. Responsive to receiving relay data frame 1812, the destination node may transmit ACK frame 1814 to the relay node to acknowledge successful reception of relay data frame 1812. Optionally, responsive to receiving ACK frame 1814, the relay node may relay ACK frame 1814 to the source node by transmitting relay ACK frame 1816. The source node may wait for T3 or T4 as shown in the diagram to receive relay ACK frame 1816.

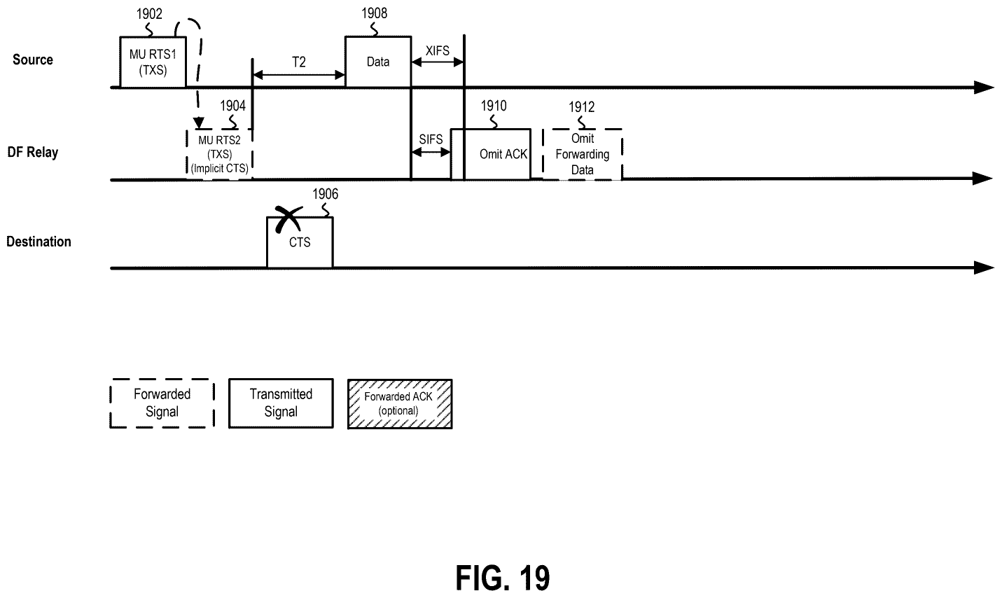

FIG. 19 is a diagram showing a frame exchange sequence based on Technique 1 Method 3 when the second RTS frame and CTS frame exchange fails, according to some embodiments.

As shown in the diagram, the source node may transmit MU RTS1 (TXS) frame 1902 to the relay node. Responsive to receiving MU RTS1 (TXS) frame 1902, the relay node may transmit MU RTS2 (TSX) frame 1904. MU RTS2 (TXS) frame 1804 may be interpreted by the source node as an implicit CTS frame (corresponding to MU RTS1 (TXS) frame 1902) and may be interpreted by the destination node as a MU RTS (TXS) frame. However, it is assumed in this example that the destination node does not successfully receive MU RTS (TXS) frame 1904 and thus the destination node does not transmit CTS frame 1906.

Responsive to receiving MU RTS2 (TXS) frame 1904 (an implicit CTS frame), the source node may transmit data frame 1908 after T2 as shown in the diagram. The relay node may refrain from transmitting ACK frame 1910 corresponding to data frame 1908 to the source node (“Omit ACK”) even though the relay node successfully receives data frame 1908 because the relay node did not successfully receive CTS frame 1906 corresponding to MU RTS2 (TXS) frame 1904. Also, the relay node may refrain from relaying data frame 1908 (“Omit Forwarding Data” 1912). After a XIFS interval (where XIFS>SIFS) or after an ACK timeout from the end of data frame 1908, the source node may determine that its data frame 1908 will not be relayed to the destination node if it has not received an ACK frame corresponding to data frame 1908. In an embodiment, the source node does not wait for a relay ACK frame in this case (e.g., does not wait for T3 and T4). Also, the source node may not retransmit data frame 1908 after the XIFS interval or the ACK timeout.

### Technique 1 Method 4—Transmission of Implicit CTS Transmission and Transmission of a CTS-to-Self Frame are Performed in the Second RTS Frame and CTS Frame Exchange Before the Source Node Transmits a Data Frame

In an embodiment (referred to herein as “Technique 1 Method 4”), as will be described in additional detail herein, an implicit CTS frame and CTS-to-self frame are transmitted in the second RTS frame and CTS frame exchange before the source node transmits a data frame.

One or more of following time offsets to be used by the source node can be defined.

T2: A time offset between the end of the PPDU that carries an implicit CTS frame (e.g., MU RTS2 (TXS) frame) and the start of the PPDU that carries a CTS-to-self frame. The time offset may be calculated by summing the estimated duration of a CTS frame corresponding to the MU RTS2 (TXS) frame and 2*aSIFSTime. If the source node receives the implicit CTS frame, T2 may start at the end of the PPDU that carries the implicit CTS frame.

T3: This time offset is the same as T3 mentioned above with regard to Technique 1 Method 1, and is not described here again for the sake of conciseness.

T4: This time offset is the same as T4 mentioned above with regard to Technique 1 Method 1, and is not described here again for the sake of conciseness.

The MU RTS (TXS) frame decoded and forwarded by the relay node can be interpreted by the source node as an implicit CTS frame.

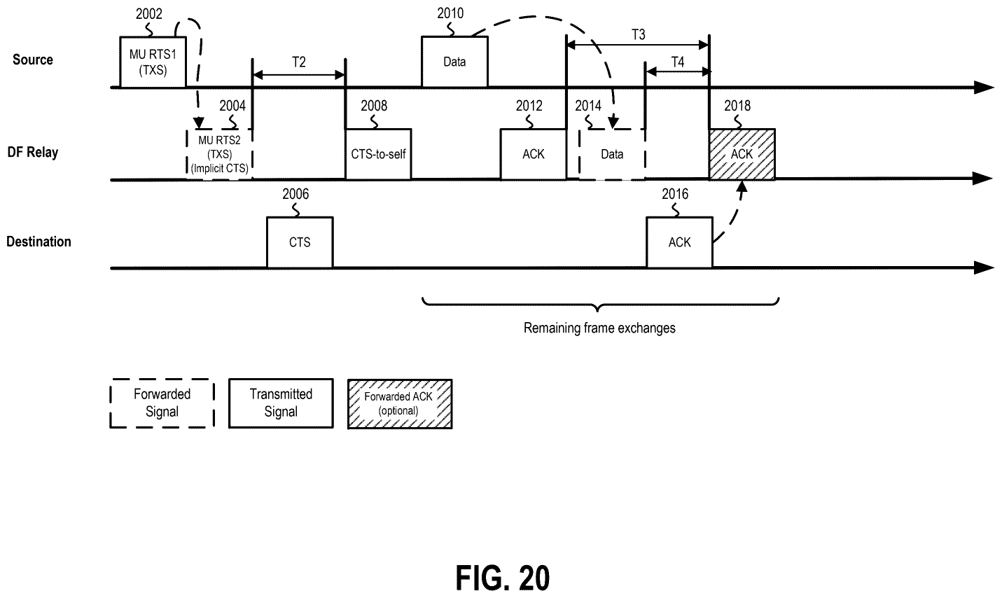

FIG. 20 is a diagram showing a frame exchange sequence based on Technique 1 Method 4, according to some embodiments.

As shown in the diagram, the source node may transmit MU RTS1 (TXS) frame 2002 to the relay node. Responsive to receiving MU RTS1 (TXS) frame 2002, the relay node may transmit MU RTS2 (TXS) frame 2004. MU RTS2 (TXS) frame 2004 may be interpreted by the source node as an implicit CTS frame (corresponding to MU RTS1 (TXS) frame 2002) and may be interpreted by the destination node as a MU RTS (TXS) frame. Responsive to receiving MU RTS2 (TXS) frame 2004, the destination node may transmit CTS frame 2006 to the relay node.

Responsive to receiving CTS frame 2006, the relay node may transmit CTS-to-self frame 2008. The source node may expect to receive CTS-to-self frame 2008 after T2 as shown in the diagram. The source node may receive CTS-to-self frame 2008 but ignore the NAV set by CTS-to-self frame 2008 or not set a NAV that can be obtained from CTS-to-self frame 2008.

Responsive to receiving CTS-to-self frame 2008, the source node may transmit data frame 2010 to the relay node (following a SIFS interval after CTS-to-self frame 2008).

The remainder of the frame exchange sequence may be similar to the frame exchange sequence shown in FIG. 14 starting from the transmission of ACK frame 1412. For example, responsive to receiving data frame 2010, the relay node may transmit ACK frame 2012 to the source node to acknowledge successful reception of data frame 2010. If the source node receives ACK frame 2012, it may know that its data frame 2010 will be relayed to the destination node.

After transmitting ACK frame 2012, the relay node may relay data frame 2010 to the destination node by transmitting relay data frame 2014. Relay data frame 2014 may include the same data that was included in data frame 2010 and decoded therefrom. Responsive to receiving relay data frame 2014, the destination node may transmit ACK frame 2016 to the relay node to acknowledge successful reception of relay data frame 2014. Optionally, responsive to receiving ACK frame 2016, the relay node may relay ACK frame 2016 to the source node by transmitting relay ACK frame 2018. The source node may wait for T3 or T4 as shown in the diagram to receive relay ACK frame 2018.

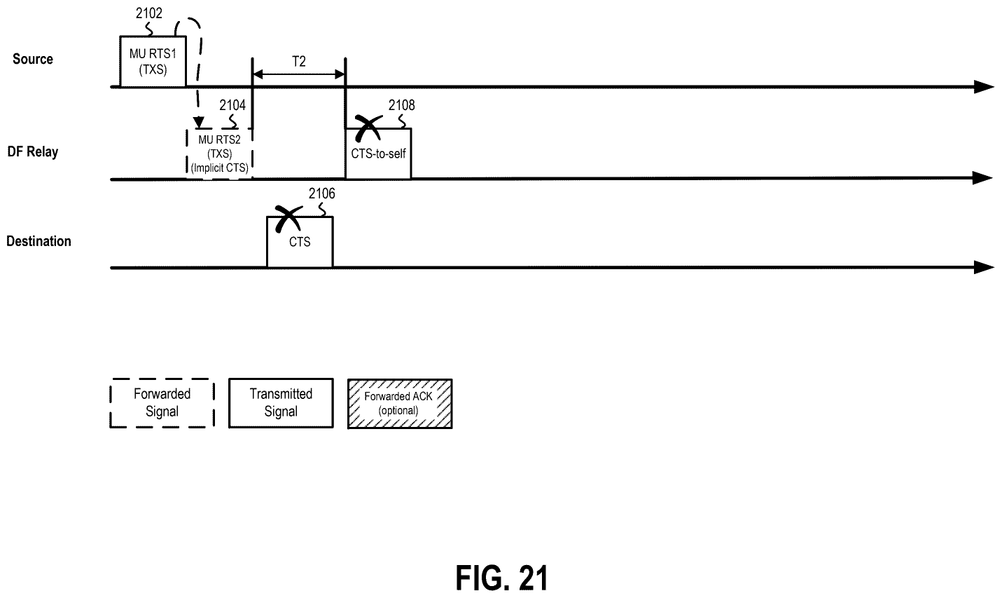

FIG. 21 is a diagram showing a frame exchange sequence based on Technique 1 Method 3 when the second RTS frame and CTS frame exchange fails, according to some embodiments.

As shown in the diagram, the source node may transmit MU RTS1 (TXS) frame 2102 to the relay node. Responsive to receiving MU RTS1 (TXS) frame 2102, the relay node may transmit MU RTS2 (TXS) frame 2104. MU RTS2 (TXS) frame 2104 may be interpreted by the source node as an implicit CTS frame (corresponding to MU RTS1 (TXS) frame 2102) and may be interpreted by the destination node as a MU RTS (TXS) frame. However, it is assumed in this example that the destination node does not successfully receive MU RTS (TXS) frame 2104 and thus the destination node does not transmit CTS frame 2106.

The relay node may refrain from transmitting CTS-to-self frame 2108 if it does not receive CTS frame 2106 corresponding to MU RTS2 (TXS) frame 2104. Also, the source node may refrain from transmitting a data frame if it does not receive CTS-to-self frame 2108 from the relay node after T2 as shown in the diagram.

If the source node is an AP, it may follow the following procedure. The AP may wait for CTSTimeout interval of (aSIFSTime+aSlotTime+aRxPHYStartDelay) that begins after (T2-aSIFSTime), where CTSTimeout interval is a CTS timeout interval, aSIFSTime is the time duration of a SIFS interval, aSlotTime is the time duration of a slot, and aRxPHYStartDelay is one or more integer delay values for each supported PHY clause, where each delay, in microseconds, is from the start of the PPDU at the receiver's antenna to the issuance of earlier of the PHYRXEARLYSIG.indication if sent or the PHY-RXSTART.indication primitive. If the MAC layer does not receive a PHY-RXSTART.indication primitive during the CTSTimeout interval, the AP may conclude that the transmission of the RTS/MU RTS2 (TXS) frame at the relay node has failed. The reception of a CTS-to-self frame from the relay node to which the MU RTS1 (TXS) frame was addressed before the PHY-RXEND.indication primitive may be interpreted as successful transmission of the RTS/MU RTS2 (TXS) frame to the non-AP STA (the destination node) from the relay node, permitting the frame exchange sequence to continue.

The above-mentioned Technique 1 Methods 1-4 may allow a source node to know whether the second RTS frame and CTS frame exchange was successfully performed more quickly compared to a source node that uses the legacy protection method shown in FIG. 12. In Technique 1 Methods 1-4, the resources to wait for the forwarded ACK at the source node are not wasted when the second RTS frame and CTS frame exchange between the relay node and the destination node fails. In Technique 1 Method 2 and Method 4, the resource to transmit a data frame are not wasted when the second RTS frame and CTS frame exchange between the relay node and the destination node fail. Technique 1 Method 1 and Method 3 may require the accurate estimation of T1 and T2 to avoid collision between the data frame and the CTS frame at the relay node. Technique 1 Method 1 and Method 3 require less latency for the source node to transmit a data frame compared to Technique 1 Method 2 and Method 4, respectively. Technique 1 Method 3 and Method 4 may reduce the MAC overhead caused by the RTS frame and CTS frame exchange compared to Technique 1 Method 1 and Method 2, respectively. Technique 1 Methods 1-4 may allow a destination node to receive a MU RTS (TXS) frame when the destination node is not available to receive an MU RTS (TXS) frame from the source node directly (i.e., without relay operations).

### Technique 2—RTS Frame and CTS Frame Exchange Sequence in an AF Relay System

With regard to Technique 2, various ways to exchange RTS frames and CTS frames in an AF relay system are described herein. Various time offsets for use with the new RTS frame and CTS frame exchange sequences can be defined. For example, the time offset for the minimum “ON” and “OFF” switching time (the time it takes for a relay node to turn on or turn off relay functionality) may be defined differently depending on the implementation. To address Issue 3 mentioned above, a MU RTS2 frame can be used as an implicit CTS frame. To address Issue 4 mentioned above, an additional frame can be transmitted after the MU RTS1 (TXS) frame is transmitted (e.g., transmit one (implicit) CTS frame and an additional frame) to allow more time for the “ON” and “OFF” switching while keeping the total overhead the same. Also, a new control frame with long duration may be used.

One or more of following time offsets to be used by the relay node or the source node can be defined.

T5: A time offset for the minimum “ON” and “OFF” switching time of the AF relay node. The time offset may be specified by a wireless networking standard (e.g., an IEEE 802.11 wireless networking standard) or it may be configured as a capability of the AF relay node. T5 may be announced to other STAs (e.g., to a source node). T5 may start at the end of the PPDU that carries a MU RTS1 (TXS) frame.

T6: A time offset that may be calculated by summing the time duration of the CTS frame transmitted by the relay node or the destination node and aSIFSTime.

T7: A time offset that may be calculated by summing the time duration of the implicit CTS frame (e.g., the time duration of the MU RTS2 frame) and aSIFSTime.

Based on the above-mentioned time offsets, one or more of the following capabilities of an AF relay node can be considered.

Capability 1 (“Capa 1”): An AF relay node implements a high speed “ON” and “OFF” switch (T5≤T6≤T7)).

Capability 2 (“Capa 2”): An AF relay node implements a medium speed “ON” and “OFF” switch (T6<T5≤T7).

Capability 3 (“Capa 3”): An AF relay node implements a low speed “ON” and “OFF” switch (T6≤T7<T5).

Also, one or more of following behaviors of an AF relay node regarding its capabilities can be considered. In an embodiment, one or more of the above-mentioned capabilities of an AF relay node can be specified in a wireless networking standard. In an embodiment, one or more of the above-mentioned capabilities of an AF relay node may be indicated/announced to other devices/STAs. In an embodiment, T5 may be indicated/announced to other devices/STAs. In an embodiment, one or more of the above-mentioned capabilities of an AF relay node can be determined by the AF relay node.

It is noted that the existing MU RTS (TXS) frame may be extended and/or reused/repurposed to include relay control information to control relay functionality of a DF relay node or an AF relay node. Such MU RTS (TXS) frame may be referred to herein as a MU RTS1 (TXS) frame.

It is noted that a DF relay node or an AF relay node may decode and forward a MU RTS1 (TXS) frame to a destination node. The decoded and forwarded MU RTS1 (TXS) frame at the relay node may be referred to herein as a MU RTS2 (TXS) frame. The information to encode a MU RTS2 (TXS) frame may be obtained by decoding a MU RTS1 (TXS) frame and/or may be obtained from decoding a management frame, control frame, and so on. Additional details of ways to encode a MU RTS1 frame and a MU RTS 2 frame are descried herein with reference to Technique 3.

### Technique 2 Method 1—No Decoding and Forwarding of a MU RTS (TXS) Frame is Performed in the Second RTS Frame and CTS Frame Exchange Before the Source Node Transmits a Data Frame

In an embodiment (referred to herein as “Technique 2 Method 1”), as will be described in additional detail herein, no decoding and forwarding of a MU RTS (TXS) frame is performed in the second RTS frame and CTS frame exchange before the source node transmits a data frame.

With Technique 2 Method 1, it is assumed that a source node knows that the AF relay node's capability is Capa 1 before the source node transmits a MU RTS1 (TXS) frame to the AF relay node. An AF relay node that receives a MU RTS1 (TXS) frame may turn on its relay functionality (switch from being in an “OFF” state to an “ON” state) before the end of the CTS frame corresponding to the MU RTS1 (TXS) frame. The source node that transmits the MU RTS1 (TXS) frame may assume that the AF relay node is in an “ON” state (relay functionality of the AF relay node is turned on) after receiving the CTS frame, so the source node may start the second RTS frame and CTS frame exchange immediately after receiving the CTS frame.

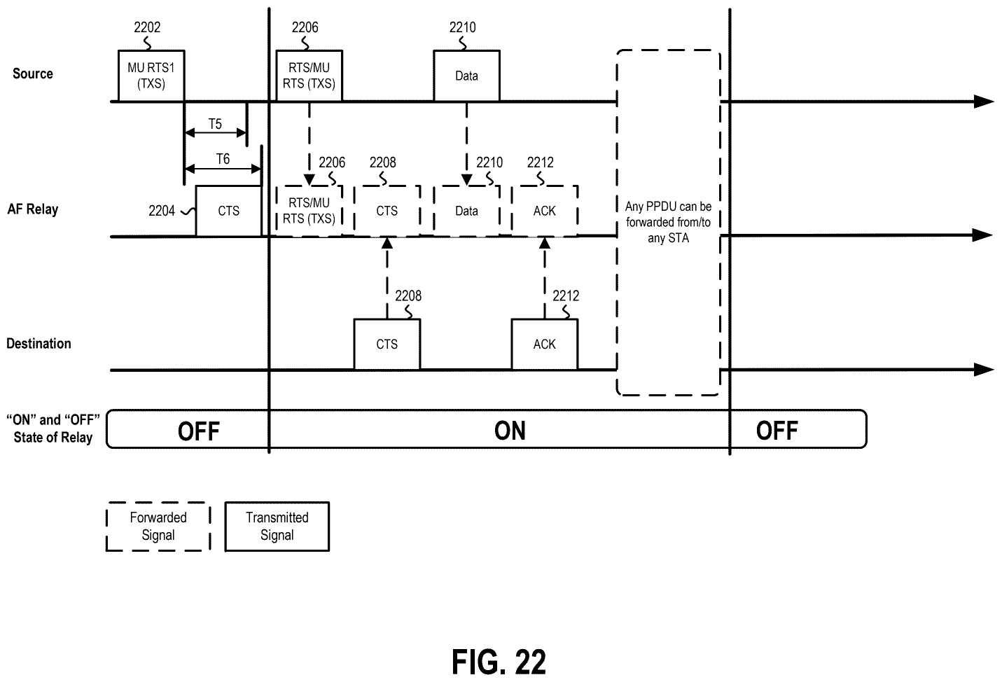

FIG. 22 is a diagram showing a frame exchange sequence based on Technique 2 Method 1, according to some embodiments.

In this example, it is assumed that the source node knows that the AF relay node's capability is Capa 1. As shown in the diagram, the source node may transmit MU RTS1 (TXS) frame 2202 to the AF relay node while the AF relay node is in the “OFF” state. Responsive to receiving MU RTS1 (TXS) frame 2202, the relay node may transmit CTS frame 2204 to the source node. Since T5 is equal to or shorter than T6, the AF relay node may be in an “ON” state after T5 but no later than T6+aSIFSTime. The source node may then transmit RTS or MU RTS (TXS) frame 2206, which is relayed by the AF relay node to the destination node. Responsive to receiving RTS or MU RTS (TXS) frame 2206, the destination node may transmit CTS frame 2208, which is relayed by the AF relay node to the source node. Responsive to receiving CTS frame 2208, the source node may transmit data frame 2210, which is relayed by the AF relay node to the destination node. Responsive to receiving data frame 2210, the destination node may transmit ACK frame 2212, which is relayed by the AF relay node to the source node. Also, the AF relay node may relay other PPDUs from/to any other devices/STAs while it is in an “ON” state.

### Technique 2 Method 2: Transmission of Implicit CTS Frame is Performed in the Second RTS Frame and CTS Frame Exchange Before the Source Node Transmits a Data Frame

In an embodiment (referred to herein as “Technique 2 Method 2”), as will be described in additional detail herein, an implicit CTS frame is transmitted in the second RTS frame and CTS frame exchange before the source node transmits a data frame. Multiple cases can be considered, as will be described in additional detail herein below.

In a first case (“Case 1”), it is assumed that the source node knows that the AF relay node's capability is Capa 1 or Capa 2 before the source node transmits a MU RTS1 (TXS) frame to the AF relay node. If the AF relay node's capability is Capa 1 or Capa 2, when the AF relay node receives a MU RTS1 (TXS) frame, it may turn on its relay functionality before the end of the implicit CTS frame (e.g., before the end of a MU RTS2 (TXS) frame) corresponding to the MU RTS1 (TXS) frame. The source node that transmits the MU RTS1 (TXS) frame may assume that the AF relay node is in an “ON” state (relay functionality of the AF relay node is turned on) after receiving the implicit CTS frame, so the source node may wait to receive a CTS frame corresponding to the MU RTS2 (TXS) frame from the destination node addressed by the MU RTS2 (TXS) frame. The source node may transmit a data frame after receiving the CTS frame.

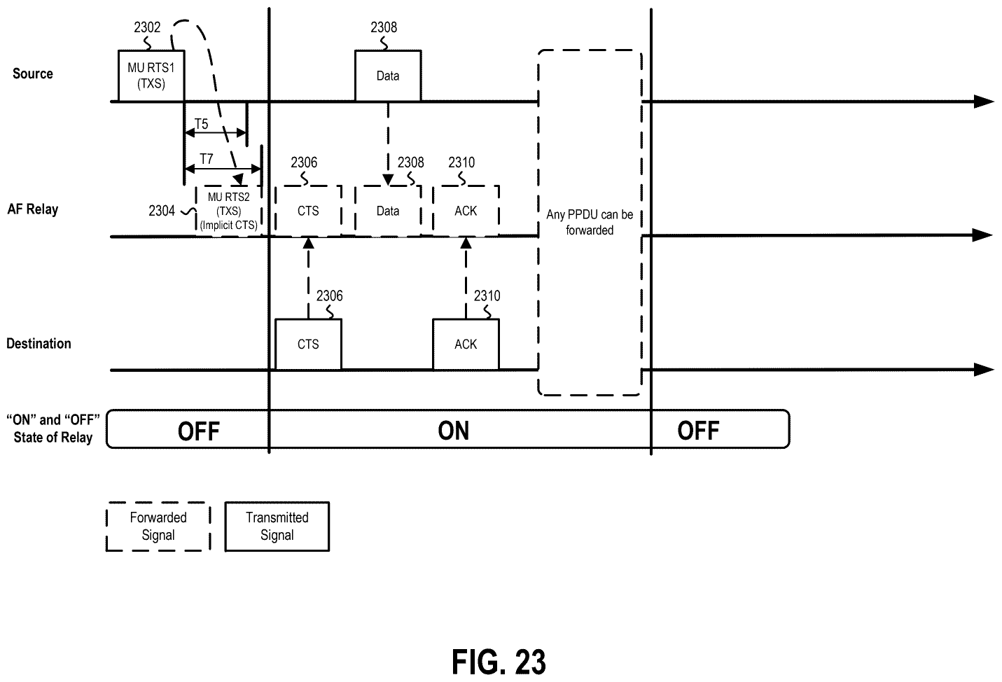

FIG. 23 is a diagram showing a frame exchange sequence based on Technique 2 Method 2 when the source node knows that the AF relay node's capability is Capa 1 or Capa 2, according to some embodiments.

In this example, it is assumed that the source node knows that the AF relay node's capability is Capa 1 or Capa 2. As shown in the diagram, the source node may transmit MU RTS1 (TXS) frame 2302 to the AF relay node while the AF relay node is in the “OFF” state. Responsive to receiving MU RTS1 (TXS) frame 2302, the AF relay node may transmit MU RTS2 (TXS) frame 2304. MU RTS2 (TXS) frame 2304 may be interpreted by the source node as an implicit CTS frame (corresponding to MU RTS1 (TXS) frame 2302). Since T5 is equal to or shorter than T7, the AF relay node may be in an “ON” state after T5 but no later than T7+aSIFSTime. Following a SIFS interval after the end of the implicit CTS frame, the source node may wait to receive CTS frame 2306 from the destination node addressed by MU RTS2 (TXS) frame 2304. Responsive to receiving MU RTS2 (TXS) frame 2304, the destination node may transmit CTS frame 2306, which is relayed by the AF relay node to the source node. Responsive to receiving CTS frame 2306, the source node may transmit data frame 2308, which is relayed by the AF relay node to the destination node. Responsive to receiving data frame 2308, the destination node may transmit ACK frame 2310, which is relayed by the AF relay node to the source node. Also, the AF relay node may relay other PPDUs from/to any other devices/STAs while it is in an “ON” state.

If the source node is an AP, it may follow the following procedure. The AP may wait for CTSTimeout interval of (aSIFSTime+aSlotTime+aRxPHYStartDelay) that begins when the MAC layer receives the PHY-TXEND.confirm primitive for the transmitted MU RTS1 (TXS) frame. If the MAC layer does not receive a PHY-RXSTART.indication primitive during the CTSTimeout interval, the AP may conclude that the transmission of the MU RTS1 (TXS) frame has failed. The AP may wait for the second CTSTimeout interval that begins at the end of the PPDU that carries the implicit CTS frame (e.g., the MU RTS2 (TXS) frame). If the MAC layer does not receive a PHY-RXSTART.indication primitive during the second CTSTimeout interval, the AP may conclude that the transmission of the MU RTS2 (TXS) frame at the relay node has failed. The reception of an implicit CTS frame from any non-AP STA of a relay node addressed by the MU RTS1 (TXS) frame before the first PHY-RXEND.indication primitive may be interpreted as successful transmission of the MU RTS1 (TXS) frame to the relay node, permitting the reception of the CTS frame from the destination node addressed by the MU RTS2 (TXS) frame. The reception of the CTS frame from any destination node addressed by the MU RTS2 (TXS) frame and/or an implicit CTS frame before the second PHY-RXEND.indication primitive may be interpreted as successful transmission of the MU RTS2 (TXS) frame by the relay node to the destination node, permitting the frame exchange sequence to continue.

In a second case (“Case 2”), it is assumed that the source node knows the AF relay node's capability is Capa 3 before the source node transmits a MU RTS1 (TXS) frame to the AF relay node. If the AF relay node's capability is Capa 3, when the AF relay node receives a MU RTS1 (TXS) frame, it is not able to turn on its relay functionality (switch from being in an “OFF” state to being in an “ON” state) before the end of the implicit CTS frame (e.g., before the end of a MU RTS2 (TXS) frame) corresponding to the MU RTS1 (TXS) frame. If the AF relay node's capability is Capa 3, when the AF relay node receives a MU RTS1 (TXS) frame, it may turn on its relay functionality on before the end of the CTS frame transmission corresponding to the MU RTS2 (TXS) frame. The source node that transmits the MU RTS1 (TXS) frame may assume that the AF relay node is in an “ON” state (relay functionality of the AF relay node is turned on) after T6 from the end of the implicit CTS frame, so the source node may wait to transmit its data frame to the destination node until after T6.

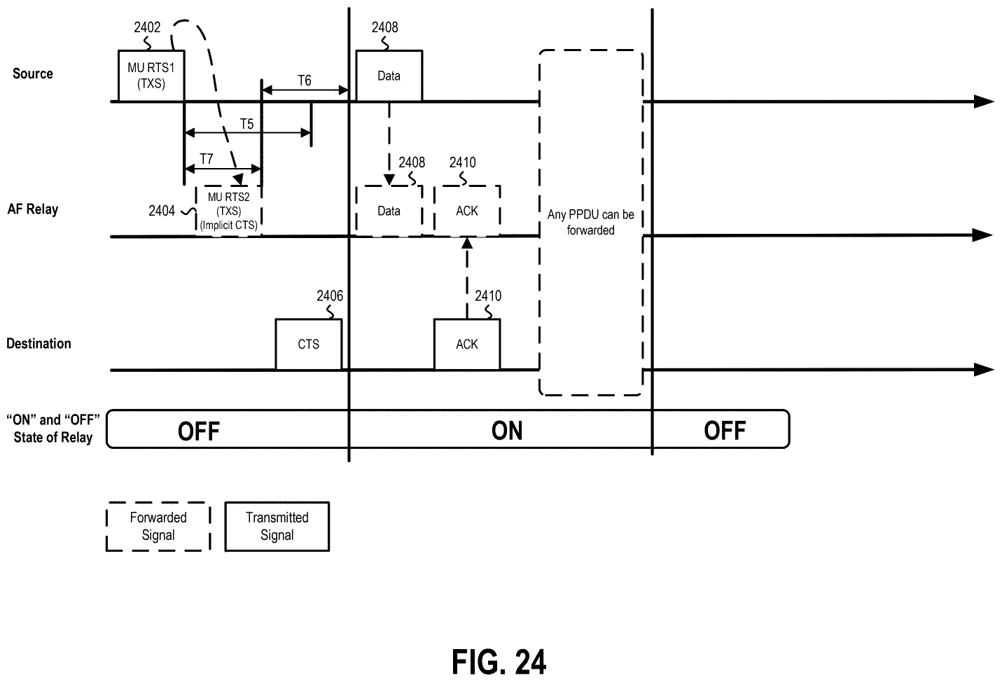

FIG. 24 is a diagram showing a frame exchange sequence based on Technique 2 Method 2 when the source node knows that the AF relay node's capability is Capa 3, according to some embodiments.

In this example, it is assumed that the source node knows that the AF relay node's capability is Capa 3. As shown in the diagram, the source node may transmit MU RTS1 (TXS) frame 2402 to the AF relay node while the AF relay node is in the “OFF” state. Since T5 is longer than T7, the AF relay node may be in an “ON” state after T5 but no later than T7+T6+aSIFSTime. Responsive to receiving MU RTS1 (TXS) frame 2402, the relay node may transmit MU RTS2 (TXS) frame 2404. MU RTS2 (TXS) frame 2404 may be interpreted by the source node as an implicit CTS frame and interpreted by the destination node as a MU RTS frame. Responsive to receiving MU RTS2 (TXS) frame 2404, the destination node may transmit CTS frame 2406 to the AF relay node. The source node that transmitted MU RTS1 (TXS) frame 2402 may wait for T6+aSIFSTime after the end of the implicit CTS frame (MU RTS2 (TXS) frame 2404) before transmitting data frame 2408. The AF relay node may relay data frame 2408 to the destination node. Responsive to receiving data frame 2408, the destination node may transmit ACK frame 2410, which is relayed by the AF relay node to the source node. Also, the AF relay node may relay other PPDUs from/to any other devices/STAs while it is in an “ON” state.

If the source node is an AP, it may follow the following procedure. After transmitting a MU RTS1 (TXS) frame, the AP may wait for CTSTimeout interval of (aSIFSTime+aSlotTime+aRxPHYStartDelay) that begins when the MAC layer receives the PHY-TXEND.confirm primitive for the transmitted MU RTS1 (TXS) frame. If the MAC layer does not receive a PHY-RXSTART.indication primitive during the CTSTimeout interval, the AP may conclude that the transmission of the MU RTS1 (TXS) frame has failed. The reception of an implicit CTS frame from any non-AP STA of a relay node addressed by the MU RTS1 (TXS) frame before the first PHY-RXEND.indication primitive may be interpreted as indicating successful transmission of the MU RTS1 (TXS) frame to the relay node, permitting the frame exchange sequence to continue after T6+aSIFSTime after the end of the PPDU that carries the implicit CTS frame.

In a third case (“Case 3”), it is assumed that the source node does not know the AF relay node's capability before the source node transmits a MU RTS1 (TXS) frame to the AF relay node. If the source node receives an implicit CTS frame (e.g., a MU RTS2 (TXS) frame) with a TA (transmitter address) field that indicates the address of the source node, the source node may assumes that the AF relay node's capability is Capa 1 or Capa 2. If the source node receives an implicit CTS frame (e.g., a MU RTS2 (TXS) frame) with a TA field that indicates the address of the AF relay node, then the source node may assume that the AF relay node's capability is Capa 3. The remaining procedure when the source node assumes that the AF relay node's capability is Capa 1 or Capa 2 may be the same as the procedure described above for Case 1 starting from the reception of the implicit CTS frame. The remaining procedure when the source node assumes that the AF relay node's capability is Capa 3 may be the same as the procedure described above for Case 2 starting from the reception of the implicit CTS frame.

### Technique 2 Method 3—Decoding and Forwarding of a MU RTS (TXS) Frame is Performed in the Second RTS Frame and CTS Frame Exchange Before the Source Node Transmits a Data Frame

In an embodiment (referred to herein as “Technique 2 Method 3”), as will be described in additional detail herein, decoding and forwarding of a MU RTS (TXS) frame is performed in the second RTS frame and CTS frame exchange before the source node transmits a data frame.

With Technique 2 Method 3, it is assumed that a source node knows that the AF relay node's capability is T5≤T7+T6 (i.e., not limits the capability of the AF relay node among Capa 1, Capa 2, Capa 3) before the source node transmits a MU RTS1 (TXS) frame to the AF relay node. The AF relay node may transmit a MU RTS2 (TXS) frame after transmitting the CTS frame corresponding to the MU RTS1 (TXS) frame. The AF relay node may turn on its relay functionality (switch from being in an “OFF” state to an “ON” state) before the end of the MU RTS2 (TXS) frame. The source node that transmits the MU RTS1 (TXS) frame may assume that the AF relay node is in an “ON” state (relay functionality of the AF relay node is turned on) after T7 after the end of the CTS frame, so the source node may wait for T7 after the CTS frame corresponding to the MU RTS1 (TXS) frame to receive the CTS frame corresponding to the MU RTS2 (TXS) frame. Alternatively, the source node that transmits the MU RTS1 (TXS) frame may assume that the AF relay node is in an “ON” state after the end of the PPDU that carries the MU RTS2 (TXS) frame, so the source node may expect to receive the CTS frame corresponding to the MU RTS2 (TXS) frame after receiving the PPDU that carries the MU RTS2 (TXS) frame.

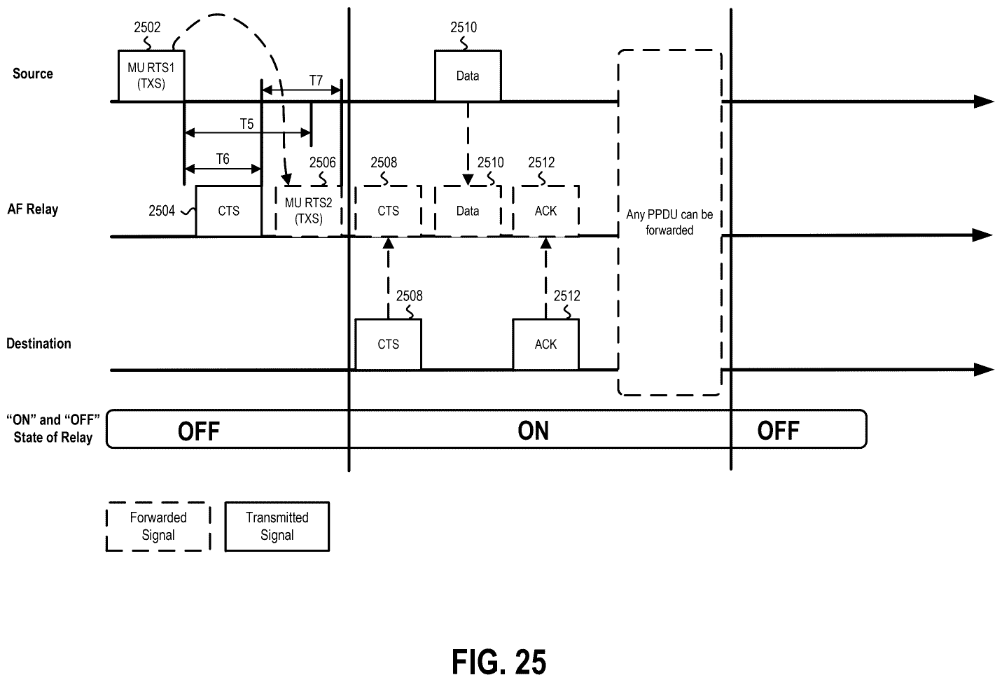

FIG. 25 is a diagram showing a frame exchange sequence based on Technique 2 Method 3, according to some embodiments.

In this example, it is assumed that the source node knows that the AF relay node's capability is T5≤T7+T6 and that Capa 3 is assumed. As shown in the diagram, the source node may transmit MU RTS1 (TXS) frame 2502 to the AF relay node while the AF relay node is in the “OFF” state. Since T5 is longer than T6, the AF relay node may be in an “ON” state after T5 but no later than T7+T6+aSIFSTime. Responsive to receiving MU RTS1 (TXS) frame 2502, the relay node may transmit CTS frame 2504 to the source node and then transmit MU RTS2 (TXS) frame 2506. The source node that transmits MU RTS1 (TXS) frame 2502 may wait for T7+aSIFSTime after receiving CTS frame 2504 to receive CTS frame 2508 corresponding to MU RTS2 (TXS) frame 2506. Alternatively, the source node that transmitted MU RTS1 (TXS) frame 2502 may receive CTS frame 2508 corresponding to MU RTS2 (TXS) frame 2506 after the end of the PPDU that carries MU RTS2 (TXS) frame 2506. Responsive to receiving MU RTS2 (TXS) frame 2506, the destination node may transmit CTS frame 2508, which is relayed by the AF relay node to the source node. Responsive to receiving CTS frame 2508, the source node may transmit data frame 2510, which is relayed by the AF relay node to the destination node. Responsive to receiving data frame 2510, the destination node may transmit ACK frame 2512, which is relayed by the AF relay node to the source node. Also, the AF relay node may relay other PPDUs from/to any other devices/STAs while it is in an “ON” state.

Technique 2 Method 4—New Control Frame is Used as a Long-CTS Frame in the First RTS Frame and CTS Frame Exchange, and No Decoding and Forwarding of a MU RTS (TXS) Frame is Performed in the Second RTS and CTS Exchange Before the Source Node Transmits a Data Frame

In an embodiment (referred to herein as “Technique 2 Method 4”), as will be described in additional detail herein, a new control frame is used as a long-CTS frame in the first RTS frame and CTS frame exchange, and no decoding and forwarding of a MU RTS (TXS) frame is performed in the second RTS and CTS exchange before the source node transmit a data frame.

An AF relay node that receives a MU RTS1 (TXS) frame may not be able to turn on its relay functionality (switch from being in an “OFF” state to an “ON” state) before the end of the CTS frame transmission corresponding to the MU RTS1 (TXS) frame. In order to meet the requirement of Capa 3, a new control frame having a duration that is longer than the legacy CTS frame but equal to or shorter than T5 may be defined. Such control frame may be referred to herein as a long-CTS frame. An AF relay node that receives a MU RTS1 (TXS) frame may be able to turn on its relay functionality before the end of the transmission of a long-CTS frame. The source node that transmits the MU RTS1 (TXS) frame may assume that the AF relay node is in an “ON” state (relay functionality of the AF relay node is turned on) after receiving the long-CTS frame. The remaining procedure for Technique 2 Method 4 may be the same as the procedure described above for Technique 2 Method 1 starting from the reception of the CTS frame.

### Technique 2 Method 5: Combination of Technique 2 Methods 1-4

In an embodiment (referred to herein as “Technique 2 Method 5”), a combination of Technique 2 Methods 1-4 may be used. It is assumed that a source node does not know the AF relay node's capability (e.g., whether the AF relay node's capability is Capa 1, Capa 2, or Capa 3) before the source node transmits a MU RTS1 (TXS) frame to the AF relay node. Various combinations of Technique 2 Methods 1-4 can be used to allow a source node to implicitly determine the AF relay node's capability based on the response to the MU RTS1 (TXS) frame received from the AF relay node. Some combinations are mentioned and described below, but it should be appreciated that other combinations are possible and are contemplated as being within the scope of the present disclosure.

In a first alternative (“Alt 1”), Technique 2 Method 1 and Case 1 of Technique 2 Method 2 can be combined. For example, if the response to the MU RTS1 (TXS) frame is a CTS frame, the source node may assume that the AF relay node's capability is Capa 1. If the response to the MU RTS1 (TXS) frame is an implicit CTS frame, the source node may assume that the AF relay node's capability is Capa 2.

In a second alternative (“Alt 2”), Technique 2 Method 1 and Case 2 of Technique 2 Method 2 can be combined. For example, if the response to the MU RTS1 (TXS) frame is a CTS frame, the source node may assume that the AF relay node's capability is Capa 1. If the response to the MU RTS1 (TXS) frame is an implicit CTS frame, the source node may assume that the AF relay node's capability is Capa 3.

In a third alternative (“Alt 3”), Technique 2 Method 3 and Case 1 of Technique 2 Method 2 can be combined. For example, if the response to the MU RTS1 (TXS) frame is a CTS frame, the source node may assume that the AF relay node's capability is Capa 3. If the response to the MU RTS1 (TXS) frame is an implicit CTS frame, the source node may assume that the AF relay node's capability is Capa 2.

After the source node determines the relay node's capability from the frame type of the response to the MU RTS1 (TXS) frame, the remaining procedure starting from the reception of the response to the MU RTS1 (TXS) frame may be the same as that of the corresponding method that uses the same response type.

Technique 2 Method 1 has the minimum impact on the existing wireless networking standard among Technique 2 Methods 1-5, but it may require that the AF relay node have a capability of Capa 1. Technique 2 Method 2 may reduce the MAC overhead incurred by RTS frame and CTS frame exchanges compared to the MAC overhead incurred in Technique 2 Method 1, Method 3, and Method 4, and it may not require that the AF relay node have a certain capability among Capa 1, Capa2, and Capa 3. Technique 2 Methods 2-4 may help solve Issue 4 mentioned above. Technique 2 Method 3 is generally more reliable than Technique 2 Method 2 when the AF relay node's capability is Capa 3, and it may not require that the AF relay node have a certain capability among Capa 1, Capa2, and Capa 3. Technique 2 Method 2 and Method 5 do not require that the AF relay node indicate/announce its capability (T5) to other devices/STAs.

### Technique 3—Encoding MU RTS Frames

With regard to Technique 3, various ways to encode a MU RTS1 (TXS) frame and a MU RTS2 (TXS) frame are described herein. A MU RTS frame can be a legacy MU RTS (TXS) frame (e.g., specified in the IEEE 802.11be wireless networking standard) or a MU RTS1 (TXS) frame that includes relay control information. If a MU RTS1 (TXS) frame is only used for relay control purposes, the response to the MU RTS1 (TXS) frame may be a legacy CTS frame or the new CTS frame mentioned above with regard to Technique 2 Method 4. After the relay node transmits a legacy CTS frame or the new CTS frame (e.g., after the relay control information is successfully indicated to the relay node), any STAs that overhear this frame may try to access the channel in a contention free manner. If a MU RTS1 (TXS) frame is used both for relay control purposes and for triggering a MU RTS2 (TXS) frame, the response to the MU RTS1 (TXS) frame may be a MU RTS2 (TXS) frame.

Various methods are described below to be able to determine whether a received MU RTS frame should be interpreted as a legacy MU RTS frame, interpreted as a MU RTS1 frame for relay control purposes only, or interpreted as a MU RTS1 frame for both relay control purposes and for purposes of triggering a MU RTS2 frame (i.e., how to encode a MU RTS1 frame and determine the purpose of the MU RTS1 frame). Also, various ways to encode a MU RTS2 frame are described herein below.

### Technique 3 Method 1: The AID12 Field Included in a MU RTS (TXS) Frame is Extended.

In an embodiment (referred to herein as “Technique 3 Method 1”), as will be described in additional detail herein, the AID12 field included in a User Info field included in a MU RTS (TXS) frame is extended to indicate whether the MU RTS (TXS) frame triggers transmission of a MU RTS2 (TXS) frame. In a MU RTS1 (TXS) frame, the (extended) AID12 field included in a User Info field for a destination node may indicate a value that is within the range of 2047 to 4094 (which is considered to be an extended range of values). The User Info field may be addressed to a destination node whose AID plus “K” (e.g., where 2046≤K≤2087) is equal to the value indicated by the (extended) AID12 field. The (extended) AID12 field for a destination node may be included in the legacy User Info field or a new variant of the User Info field (referred to herein as a “Relayed User Info” field). The User Info field may be addressed to a relay node whose AID is equal to the value indicated by the AID12 field.

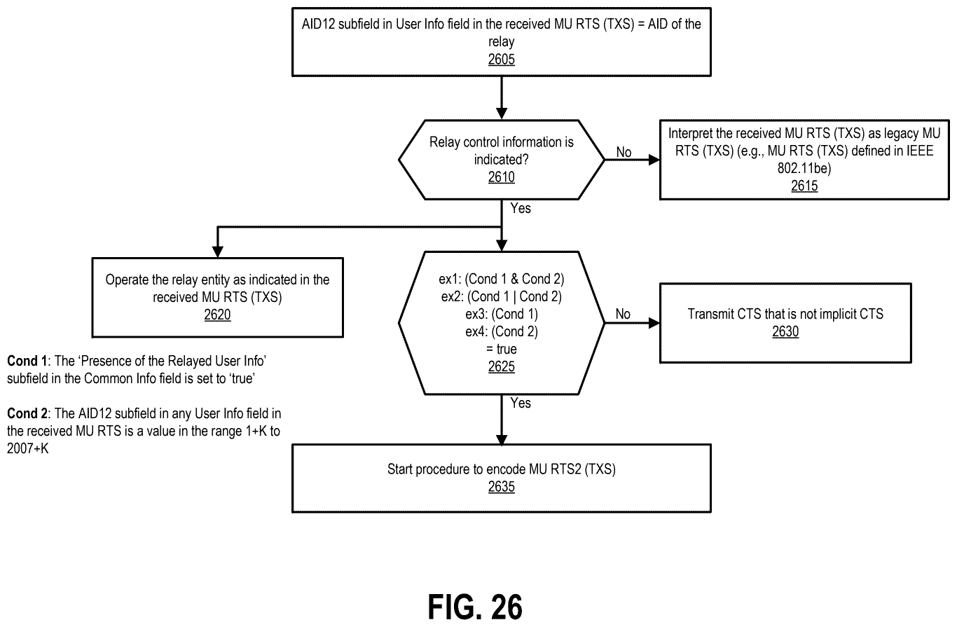

FIG. 26 is a diagram showing a method performed by a relay node to determine whether a received MU RTS (TXS) frame triggers transmission of a MU RTS2 (TXS) frame based on Technique 3 Method 1, according to some embodiments.

At operation 2605, the relay node determines that the AID12 field included in the User Info field included in the received MU RTS (TXS) frame indicates a value that corresponds to the AID of the relay node (i.e., the User Info field is addressed to the relay node).

At operation 2610, the relay node determines whether the MU RTS (TXS) frame indicates relay control information. If the received MU RTS (TXS) frame does not indicate relay control information, the method may proceed to operation 2615. At operation 2615, the relay node interprets the received MU RTS (TXS) frame as a legacy MU RTS (TXS) frame (e.g., the MU RTS (TXS) frame defined in the IEEE 802.11be wireless networking standard). Otherwise, if the received MU RTS (TXS) frame indicates relay control information, the relay node interprets the receive MU RTS (TXS) frame as a MU RTS1 (TXS) frame and at operation 2620, the relay node operates the relay entity as indicated by the MU RTS (TXS) frame. Also, at operation 2625, the relay node determines whether either or both of the conditions below are satisfied:

Condition 1 (“Cond 1”): The “Presence of Relayed User Info” field included in the Common Info field included in the received MU RTS (TXS) frame indicates a value of “true” (indicates that a Relayed User Info field is present in the received MU RTS (TXS) frame).

Condition 2 (“Cond 2”): The AID12 field included in any of the User Info fields included in the received MU RTS (TXS) frame indicates a value that is within the range 1+K to 2007+K (the value is within an extended range of values).

The decision criterion at operation 2625 may be one of the following:
Example 1 (“ex1”): Both Cond 1 and Cond 2 are “true” (“Cond 1 & Cond 2”);
Example 2 (“ex2”): Either Cond 1 or Cond 2 is “true” (“Cond 1|Cond 2”);
Example 3 (“ex3”): Cond 1 is “true”; or
Example 4 (“ex4”): Cond 1 is “true”;

If the decision criterion is not “true,” the method may proceed to operation 2630. At operation 2630, the relay node transmits a CTS frame that is not an implicit CTS frame. Otherwise, if the decision criterion is “true,” the method proceeds to operation 2635. At operation 2635, the relay node starts a procedure to encode a MU RTS2 (TXS) frame.

### Encoding a MU RTS2 (TXS) Frame

If the implicit CTS frame format is the MU RTS frame, the MU RTS1 (TXS) frame may have multiple User Info fields whose AID12 field indicates a value that is in the range from 1+K to 2007+K. If the implicit CTS frame format is the MU RTS TXS frame, the MU RTS1 (TXS) frame may have only one User info field whose AID12 field indicates a value that is in the range from 1+K to 2007+K.

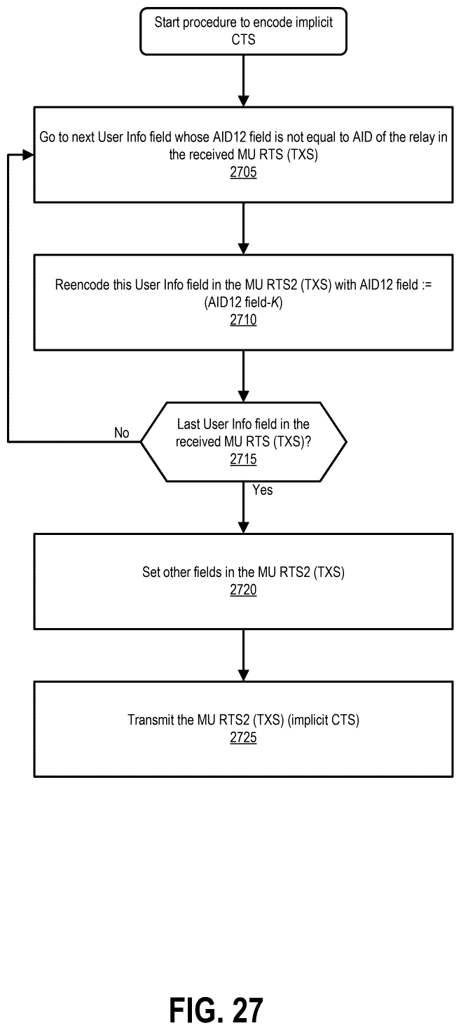

FIG. 27 is a diagram showing a method performed by a relay node to encode a MU RTS2 (TXS) frame based on Technique 3 Method 1, according to some embodiments.

Th method may start at operation 2705. At operation 2705, the relay node may go to the next User Info field included in the received MU RTS1 (TXS) frame whose AID12 field does not indicate a value that corresponds to the AID of the relay node. At operation 2710, the relay node may reencode this User Info field in the MU RTS2 (TXS) frame by replacing the (extended) AID12 subfield as follows.

The AID12 field included in the User Info field included in the MU RTS2 (TXS) frame may be set to the value indicated by the AID12 field included in the User Info field included in the received MU RTS1 (TXS) frame minus “K.” For example, when “K” is 2048, the AID12 field included in the User Info field included in the MU RTS2 (TXS) frame may be set to the value indicated by the AID12 field included in the User Info field included in the received MU RTS1 (TXS) frame by replacing its most significant bit (MSB) that is “1” with “0.”

At operation 2715, the relay node may determine whether the current User Info field being processed is the last User Info field included in the received MU RTS1 (TXS) frame. If the User Info field is not the last User Info field included in the received MU RTS1 (TXS) frame, then the method may proceed to operation 2705 to process the next User Info field. Otherwise, if the User Info field is the last User Info field included in the received MU RTS1 (TXS) frame, the method may proceed to operation 2720. At operation 2720, the relay node may set the other fields included in the MU RTS2 (TXS) frame as follows:

The Duration/ID field may be set to: (the time duration indicated by the Duration/ID field included in the MU RTS1 (TXS) frame)-(the time duration between the start and the end of the PPDU that carries the MU RTS1 (TXS) frame)-(aSIFSTime).

If the relay node is a DF relay node, the TA field may be set to the address of the relay node. If the relay node is an AF relay node, the TA field may be set to the address of the relay node when the relay node receives a CTS frame corresponding to the MU RTS2 (TXS) frame.

If the relay node is an AF relay node, the TA field may be set to the value indicated by the TA field included in the MU RTS1 (TXS) frame when the source node that transmitted the MU RTS1 (TXS) frame receives a CTS frame corresponding to the MU RTS2 (TXS) frame.

The (sub) fields to control the relay node in the MU RTS1 (TXS) may be (partially) omitted.

At operation 2725, the relay node may transmit the MU RTS (TXS) frame (e.g., which can be interpreted by the source node as an implicit CTS frame).

### Technique 3 Method 2: The RA Field Included in a MU RTS (TXS) Frame is Extended.

In an embodiment (referred to herein as “Technique 3 Method 2”), as will be described in additional detail herein, the RA (Receiver Address) field included in a User Info field for a destination node included in a MU RTS (TXS) frame is extended to indicate whether the MU RTS (TXS) frame triggers transmission of a MU RTS2 (TXS) frame. For example, the (extended) RA field indicating a broadcast address may indicate that the MU RTS (TXS) frame does not trigger transmission of a MU RTS2 (TXS) frame and the (extended) RA field indicating the address of the relay node may indicate that the MU RTS (TXS) frame triggers transmission of a MU RTS2 (TXS) frame.

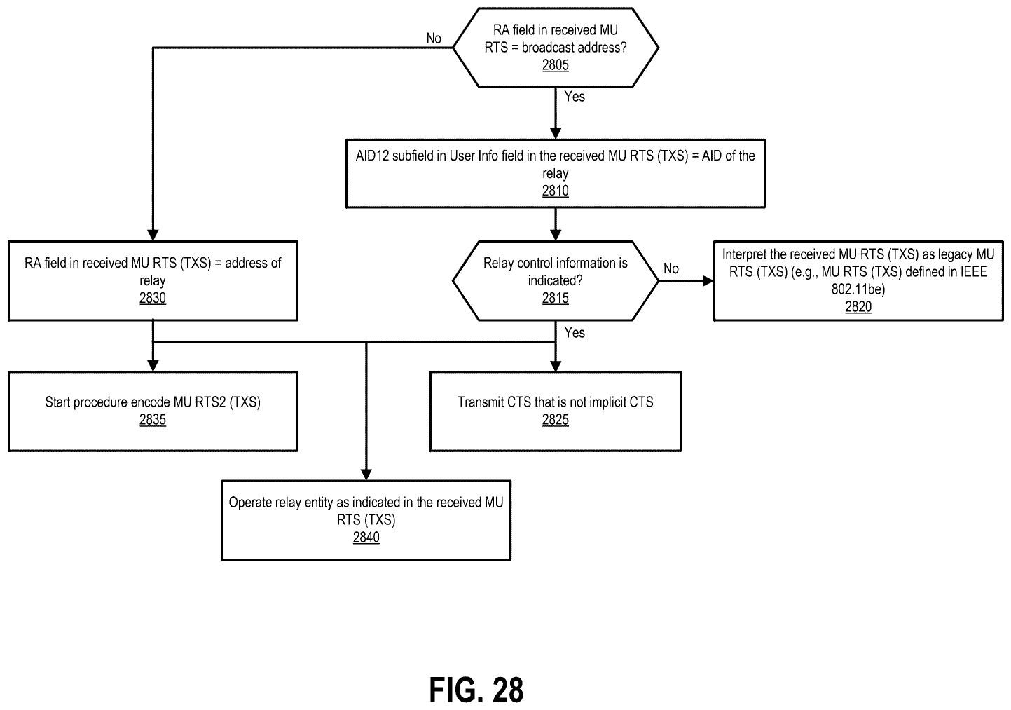

FIG. 28 is a diagram showing a method performed by a relay node to determine whether a received MU RTS (TXS) frame triggers transmission of a MU RTS2 (TXS) frame based on Technique 3 Method 2, according to some embodiments.

At operation 2805, the relay node may determine whether the RA field included in the received MU RTS (TXS) frame indicates a broadcast address. If the RA field indicates a broadcast address, then the method proceeds to operation 2810. At operation 2810, the relay node may determine that the AID12 field included in the User Info field included in the received MU RTS (TXS) frame indicates a value that corresponds to the AID of the relay node (i.e., the User Info field is addressed to the relay node). At operation 2815, the relay node may determine whether the MU RTS (TXS) frame indicates relay control information. If the received MU RTS (TXS) frame does not indicate relay control information, the method may proceed to operation 2820. At operation 2820, the relay node may interpret the received MU RTS (TXS) frame as a legacy MU RTS (TXS) frame (e.g., the MU RTS (TXS) frame defined in the IEEE 802.11be wireless networking standard). Otherwise, if the received MU RTS (TXS) frame indicates relay control information, the method may proceed to operation 2825. At operation 2825, the relay node may transmit a CTS frame that is not an implicit CTS frame. Also, at operation 2840, the relay node may operate the relay entity (operate relay functionality) as indicated by the received MU RTS (TXS) frame.

Returning to operation 2805, if the RA field does not indicate a broadcast address, then the method may proceed to operation 2830. At operation 2830, the relay node may determine that the RA field indicates a value that corresponds to the address of the relay node. In this case, the relay node may interpret the MU RTS (TXS) frame as a MU RTS1 (TXS) frame. Accordingly, at operation 2835, the relay node may start the procedure to encode a MU RTS2 (TXS) frame. Also, in this case, the relay node may perform operation 2840 (where it operates the relay entity as indicated by the received MU RTS (TXS) frame).

### Encoding of the MU RTS2 (TXS) Frame

The relay node may set the field(s) included in the MU RTS2 (TXS) frame as follows:

The Duration/ID field may be set to (the time duration indicated by the Duration/ID field included in the MU RTS1 (TXS) frame)-(the time duration between the start and the end of the PPDU that carries the MU RTS1 (TXS) frame)-(aSIFSTime).

The RA field may be set to the broadcast address.

If the relay node is a DF relay node, the TA field may be set to the address of the relay node. If the relay node is an AF relay node, the TA field may be set to the address of the relay node when the relay node receives a CTS frame corresponding to the MU RTS2 (TXS) frame.

If the relay node is an AF relay node, the TA field may be set to the value indicated by the TA field included in the MU RTS1 (TXS) frame when the source node that transmitted the MU RTS1 (TXS) frame receives a CTS frame corresponding to the MU RTS2 (TXS) frame. The (sub) fields to control the relay node in the MU RTS1 may be (partially) omitted.

### Technique 3 Method 3: The RU Allocation Field Included in a MU RTS (TXS) Frame is Extended.

In an embodiment (referred to herein as “Technique 3 Method 3”), as will be described in additional detail herein, the RU Allocation field included in a User Info field included in a MU RTS (TXS) frame is extended to indicate whether the MU RTS (TXS) frame triggers transmission of a MU RTS2 (TXS) frame.

The RU Allocation field may be extended in the following ways.

In an embodiment (referred to herein as “Alt 1”), bits B7-B1 of the (extended) RU Allocation field included in the User Info field for a destination node included in a received MU RTS (TXS) frame is encoded with a value from 102 to 107 and bits B7-B1 of the (extended) RU Allocation field included in the User Info field for the relay node included in the received MU RTS (TXS) frame is encoded with a value from 0 to 106 (e.g., as specified in the IEEE 802.11be wireless networking standard).

In an embodiment (referred to herein as “Alt 2”), the encoding of the (extended) RU Allocation fields is the same as Alt 1.

In an embodiment (referred to herein as “Alt 3”), a “Relayed User Info Indication” field is included in bits B29-B38 of a User Info field for a destination node. One value of the Relayed User Info Indication field that is not a reserved value may indicate this User Info field is a “Relayed TXS User Info” field.

The Special User Info field is not considered in Technique 3 Method 3.

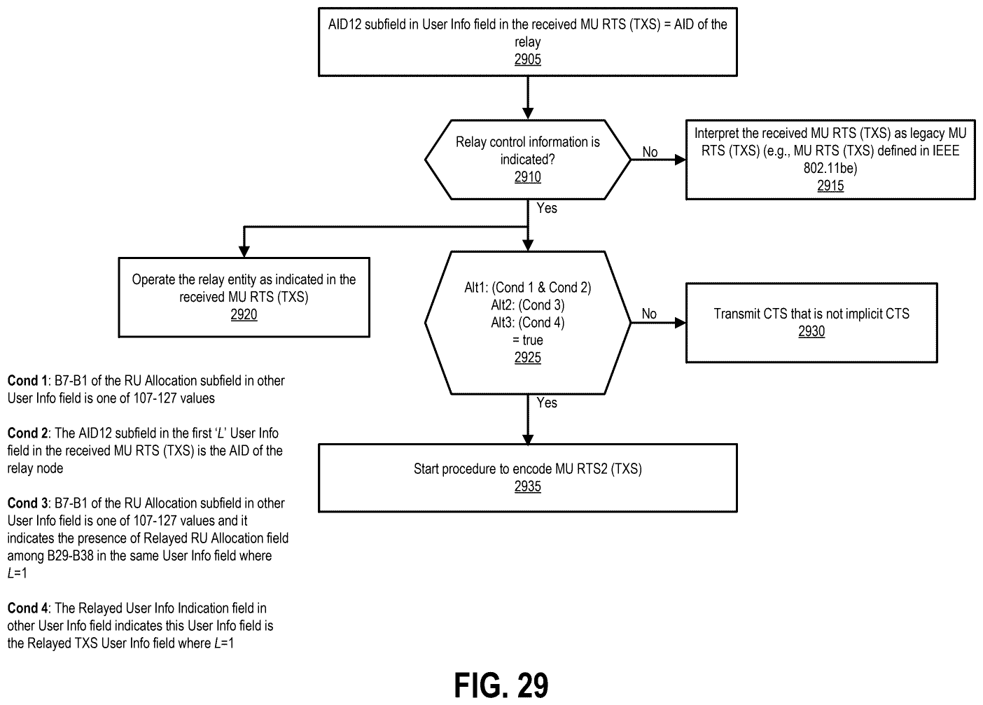

FIG. 29 is a diagram showing a method performed by a relay node to determine whether a received MU RTS (TXS) frame triggers transmission of a MU RTS2 (TXS) frame based on Technique 3 Method 3, according to some embodiments.

At operation 2905, the relay node may determine that the AID12 field included in the User Info field included in the received MU RTS (TXS) frame indicates a value that corresponds to the AID of the relay node (i.e., the User Info field is addressed to the relay node).

At operation 2910, the relay node may determine whether the MU RTS (TXS) frame indicates relay control information. If the received MU RTS (TXS) frame does not indicate relay control information, the method may proceed to operation 2915. At operation 2915, the relay node may interpret the received MU RTS (TXS) frame as a legacy MU RTS (TXS) frame (e.g., the MU RTS (TXS) frame defined in the IEEE 802.11be wireless networking standard). Otherwise, if the received MU RTS (TXS) frame indicates relay control information, the relay node may interpret the received MU RTS (TXS) frame as a MU RTS1 (TXS) frame and at operation 2920, the relay node may operate the relay entity as indicated by the MU RTS (TXS) frame.

At operation 2925, the relay node may determine whether certain conditions are satisfied.

In the case of Alt 1, if the received MU RTS (TXS) frame is a MU RTS1 (TXS) frame, the relay node may determine whether the below conditions are satisfied:

Condition 1 (“Cond 1”): Bits B7-B1 of the RU Allocation field included in another User Info field indicates a value in the range from 107 to 127.

Condition 2 (“Cond 2”): An AID12 field included in the first “L” User Info fields included in the received MU RTS frame indicates a value that corresponds to the AID of the relay node.

In the case of Alt 2, if the received MU RTS (TXS) frame is a MU RTS1 (TXS) frame, the relay node may determine whether the below condition is satisfied:

Condition 3 (“Cond 3”): Bits B7-B1 of the RU Allocation field included in another User Info field indicates a value in the range from 107 to 127 and indicates the presence of a “Relayed RU Allocation” field among bits B29-B38 of the same User Info field where L=1.

In the case In Alt 3, if the received MU RTS (TXS) frame is a MU RTS1 (TXS) frame, the relay node may determine whether the below condition is satisfied:

Condition 4 (“Cond 4”): The Relayed User Info Indication field included in another User Ino field indicates that this User Info field is the “Relayed TXS User Info” field where L=1.

“L” is the number of User Info fields for destination nodes or “L” is the number of User Info fields included in the MU RTS2 (TXS) frame. It is noted that the number of User Info field included in the MU RTS1 (TXS) frame is “2*L.” Also, it is noted that “other” User Info field in this context means that this User Info is for a destination node.

The decision criterion at operation 2625 may be one of the following depending on which Alt is being used:

In the case of Alt 1, the relay node may determine whether both Cond 1 and Cond 2 are “true” (“Cond 1 & Cond 2”). In the case of Alt 2, the relay node may determine whether Cond 3 is “true.” In the case of Alt 3, the relay node may determine whether Cond 4 is “true.”

If the decision criterion is not “true,” the method may proceed to operation 2930. At operation 2930, the relay node may transmits a CTS frame that is not an implicit CTS frame. Otherwise, if the decision criterion is “true,” the method may proceed to operation 2935. At operation 2935, the relay node may start a procedure to encode a MU RTS2 (TXS) frame.

### Encoding of the MU RTS2 (TXS) Frame

The relay node may set the User Info field(s) included in the MU RTS2 (TXS) frame as follows.

In the case of Alt 1, the RU Allocation field included in the l-th User Info field included in the MU RTS2 (TXS) frame may be set to indicate the value of the RU Allocation field included in the l-th User Info field included in the MU RTS1 (TXS) frame. The fields included in the l-th User Info field included in the MU RTS2 (TXS) frame other than the RU Allocation field may be set to indicate the same value as indicated by the corresponding fields included in the (L+l)-th User Info field included in the MU RTS1 (TXS) frame.

In the case of Alt 2, the RU Allocation field included in the User Info field included in the MU RTS2 (TXS) frame may be set to indicate the value indicated by the Relayed RU Allocation field included in the corresponding User Info field included in the MU RTS1 (TXS) frame. The fields included in the User Info field included in the MU RTS2 TXS frame other than the RU Allocation field and the Relayed RU Allocation field may be set to indicate the same value as indicated by the corresponding fields included in the corresponding User Info field included in the MU RTS1 (TXS) frame.

In the case of Alt 3, bits B29-B38 may be set to the reserved value used in B29-B38 of the User Info field included in the MU RTS1 (TXS) frame (e.g., as defined in the IEEE 802.11be wireless networking standard). The fields included in the User Info field included in the MU RTS2 (TXS) frame other than the “Relayed User Info Indication” field may be set to indicate the same value as indicated by the corresponding fields included in the corresponding User Info field included in the MU RTS1 (TXS) frame.

The relay node may set the field(s) included in the MU RTS2 (TXS) frame as follows:

The Duration/ID field may be set to (the time duration indicated by the Duration/ID field included in the MU RTS1 (TXS) frame)-(the time duration between the start and the end of the PPDU that carries the MU RTS1 (TXS) frame)-(aSIFSTime).

If the relay node is a DF relay node, the TA field may be set to the address of the relay node. If the relay node is an AF relay node, the TA field may be set to the address of the relay node when the relay node receives a CTS frame corresponding to the MU RTS2 (TXS) frame.

If the relay node is an AF relay node, the TA field may be set to the value indicated by the TA field included in the MU RTS1 frame when the source node that transmitted the MU RTS1 (TXS) frame receives a CTS frame corresponding to the MU RTS2 (TXS) frame.

The (sub) fields to control the relay node in the MU RTS1 (TXS) frame may be (partially) omitted.

In the case of Alt 2 or Alt 3, the MU RTS2 (TXS) frame is a MU RTS TXS frame (e.g., the MU RTS frame may not be available for these Alts).

### Technique 3 Method 4: The Common Info Field is Extended

In an embodiment (referred to herein as “Technique 3 Method 4”), as will be described in additional detail herein, the Common Info field included in a MU RTS (TXS) frame is extended to indicate whether the MU RTS (TXS) frame triggers transmission of a MU RTS2 (TXS) frame. For example, the Common Info field may be extended to include a “Presence of the Relayed User Info” field. If the Presence of the Relayed User Info field indicates that a Relayed User Info field is present in the MU RTS (TXS) frame (e.g., the Presence of the Relayed User Info field indicates a value of “true”), the first User Info field included in the MU RTS (TXS) frame may be addressed to a relay node whose AID corresponds to the value indicated by the AID12 field included in that User Info field and the other User Info field(s) may be addressed to destination node(s) that have not been indicated as being a relay node whose AID corresponds to the value indicated by the AID12 field included in the other User Info field(s). Thus, if the Presence of the Relayed User Info field indicates that a Relayed User Info field is present in the MU RTS (TXS) frame, the User Info field(s) other than the first User Info field may be interpreted as being Relayed User Info fields.

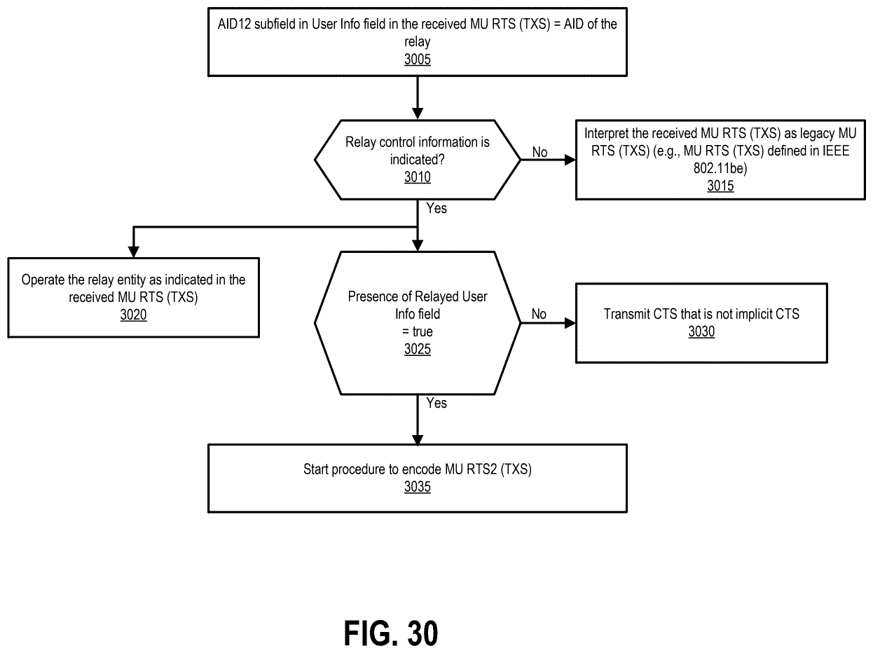

FIG. 30 is a diagram showing a method performed by a relay node to determine whether a received MU RTS (TXS) frame triggers transmission of a MU RTS2 frame based on Technique 3 Method 4, according to some embodiments.

At operation 3005, the relay node may determine that the AID12 field included in the User Info field included in the received MU RTS (TXS) frame indicates a value that corresponds to the AID of the relay node (i.e., the User Info field is addressed to the relay node).

At operation 3010, the relay node may determine whether the received MU RTS (TXS) frame indicates relay control information. If the received MU RTS (TXS) frame does not indicate relay control information, the method may proceed to operation 3015. At operation 3015, the relay node may interpret the received MU RTS (TXS) frame as a legacy MU RTS (TXS) frame (e.g., the MU RTS (TXS) frame defined in the IEEE 802.11be wireless networking standard). Otherwise, if the received MU RTS (TXS) frame indicates relay control information, the relay node may interpret the received MU RTS (TXS) frame as a MU RTS1 (TXS) frame and at operation 3020, the relay node may operate the relay entity as indicated by the MU RTS (TXS) frame.

At operation 3025, the relay node may determine whether the Presence of the Relayed User Info (included in the Common Info field) indicates a value of “true” (e.g., indicates that a Relayed User Info field is present). If the Presence of the Relayed User Info does not indicate a value of “true,” the method may proceed to operation 3030. At operation 3030, the relay node transmits a CTS frame that is not an implicit CTS frame. Otherwise, if the Presence of the Relayed User Info indicates a value of “true,” the method may proceed to operation 3035. At operation 3035, the relay node may start a procedure to encode a MU RTS2 (TXS) frame.

### Encoding of the MU RTS2 (TXS) Frame

The relay node may set the User Info field(s) included in the MU RTS2 (TXS) frame as follows.

The User Info field included in the MU RTS2 (TXS) frame may be set to the same value indicated by the Relayed User Info field included in the MU RTS1 (TXS) frame.

The Duration/ID field may be set to (the time duration indicated by the Duration/ID field included in the MU RTS1 (TXS) frame)-(the time duration between the start and the end of the PPDU that carries the MU RTS1 (TXS) frame)-(aSIFSTime).

If the relay node is a DF relay node, the TA field may be set to the address of the relay node. If the relay node is an AF relay node, the TA field may be set to the address of the relay node when the relay node receives a CTS frame corresponding to the MU RTS2 (TXS) frame.

If the relay node is an AF relay node, the TA field may be set to the value indicated by the TA field included in the MU RTS1 frame when the source node that transmitted the MU RTS1 (TXS) frame receives a CTS frame corresponding to the MU RTS2 (TXS) frame.

The (sub) fields to control the relay node in the MU RTS1 (TXS) frame may be (partially) omitted.

The different methods of Technique 3 (Technique 3 Methods 1-4) touch different fields included in a MU RTS (TXS) frame. Technique 3 Method 1 uses the reserved values of the AID12 field. Technique 3 Method 2 releases the restriction of the RA field included in a MU RTS (TXS) frame. Alt 1 and Alt 2 of Technique 3 Method 3 use the reserved values of the RU allocation field. Alt 3 of Technique 3 Method 3 uses the reserved values of the User Info field included in a MU RTS TXS frame. Technique 3 Method 4 uses the reserved values of the Common Info field. Technique 3 Method 2 and Method 4 may control multiple relay nodes when not triggering the transmission of a MU RTS2 (TXS) frame.

In an embodiment, the techniques described herein can be applied to a roaming scenario. In a roaming scenario, a STA may roam from a source AP to a target AP. The source AP may forward downlink (DL) data intended for a (non-AP) STA to a target AP via a wireless backhaul link so that the STA can receive the DL data after it connects with the target AP. This operation can be viewed as the target AP relaying DL data transmitted by the source AP to the STA. Thus, the relay techniques described herein can be applied to such scenario, where the source node is the source AP, the relay node is the target AP, and the destination node is the STA.

Various mechanisms to decode and forward a MU RTS frame or MU RTS TXS frame in a DF relay system and an AF relay system have been described herein. These mechanisms may provide one or more of the following advantages:

Multiple destination nodes can be supported by OFDMA technologies in a DF relay system and an AF relay system.

When a relay node is an AF relay, various capability of the “ON” and “OFF” switching times of the relay functionality can be supported.

Unexpected noise and interference are not amplified and forwarded when there is no signal to be relayed to a destination node.

Power and/or time resource to operate a relay node (a AF relay node or a DF relay node) can be saved.

The transmission of relayed data can be protected considering the hidden node problem caused by the extended transmission range of the relay node.

Performance of rate-vs-range throughput of a STA can be improved.

While certain advantages are mentioned above, one of ordinary skill in the relevant art will appreciate that the techniques described herein may provide other advantages in view of the present disclosure.

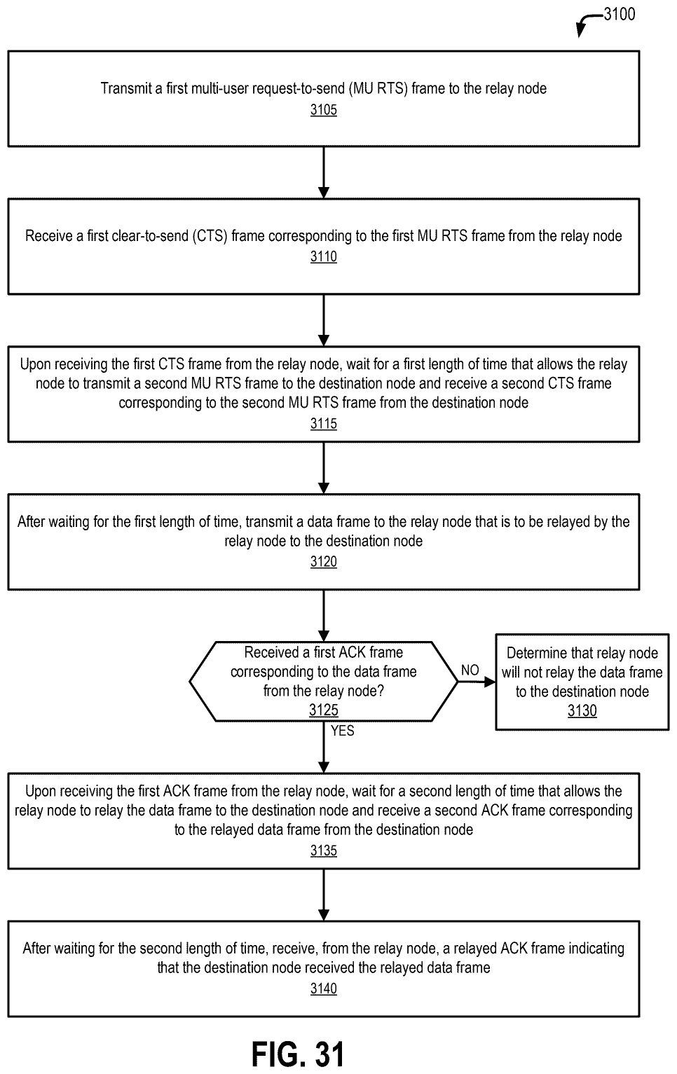

Turning now to FIG. 31, a method 3100 will be described for a source node to transmit data to a destination node via a relay node based on Technique 1 Method 1, in accordance with an example embodiment. The method 3100 may be performed by a source node. The source node may be a wireless device (e.g., wireless device 104).

Additionally, although shown in a particular order, in some embodiments the operations of the method 3100 (and the other methods shown in the other figures) may be performed in a different order. For example, although the operations of the method 3100 are shown in a sequential order, some of the operations may be performed in partially or entirely overlapping time periods.

At operation 3105, the source node transmits a first MU RTS frame to the relay node.

At operation 3110, the source node receives a first CTS frame corresponding to the first MU RTS frame from the relay node.

At operation 3115, upon receiving the first CTS frame from the relay node, the source node waits for a first length of time that allows the relay node to transmit a second MU RTS frame to the destination node and receive a second CTS frame corresponding to the second MU RTS frame from the destination node.

At operation 3120, after waiting for the first length of time, the source node transmits a data frame to the relay node that is to be relayed by the relay node to the destination node.

At operation 3125, the source node determines whether it received a first ACK frame corresponding to the data frame from the relay node. If the source node did not receive the first ACK frame, the method proceeds to operation 3130. At operation 3130, the source node determines that the relay node will not relay the data frame to the destination node. If the source node received the first ACK frame, the method proceeds to operation 3135. At operation 3135, upon receiving the first ACK frame from the relay node, the source node waits for a second length of time that allows the relay node to relay the data frame to the destination node and receive a second ACK frame corresponding to the relayed data frame from the destination node.

At operation 3140, after waiting for the second length of time, the source node receives, from the relay node, a relayed ACK frame indicating that the destination node received the relayed data frame.

In an embodiment, the source node is a source AP, the relay node is a target AP, and the destination node is a non-AP STA that roams from the source AP to the target AP.

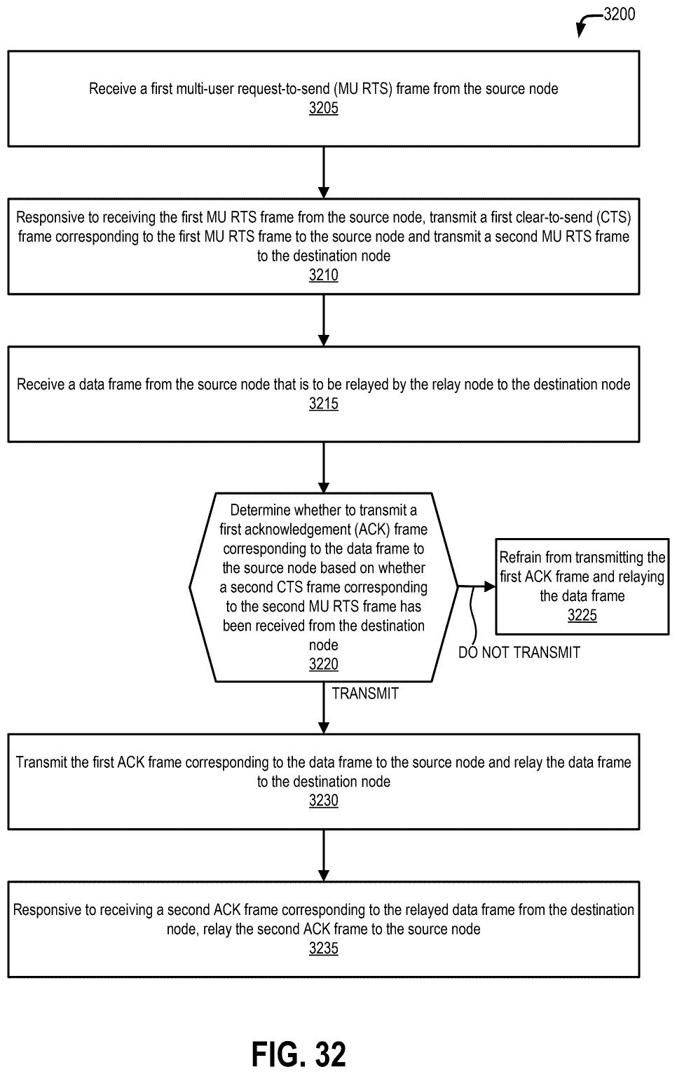

Turning now to FIG. 32, a method 3200 will be described for a relay node to relay data transmitted by a source node to a destination node based on Technique 1 Method 1, in accordance with an example embodiment. The method 3200 may be performed by a relay node. The relay node may be a wireless device (e.g., wireless device 104).

At operation 3205, the relay node receives a first MU RTS frame from the source node.

At operation 3210, responsive to receiving the first MU RTS frame from the source node, the relay node transmits a first CTS frame corresponding to the first MU RTS frame to the source node and transmits a second MU RTS frame to the destination node.

At operation 3215, the relay node receives a data frame from the source node that is to be relayed by the relay node to the destination node.

At operation 3220, the relay node determines whether to transmit a first ACK frame corresponding to the data frame to the source node based on whether a second CTS frame corresponding to the second MU RTS frame has been received from the destination node. For example, the relay node may determine to transmit the first ACK frame if the relay node receives the second CTS frame from the destination node, but may determine not to transmit the first ACK frame if the relay node does not receive the second CTS frame from the destination node. If the relay node determines not to transmit the first ACK frame, the method proceeds to operation 3225. At operation 3225, the relay node refrains from transmitting the first ACK frame corresponding to the data frame to the source node and refrains from relaying the data frame to the destination node. If the relay node determines to transmit the first ACK frame, the method proceeds to operation 3230. At operation 3230, the relay node transmits the first ACK frame corresponding to the data frame to the source node and relays the data frame to the destination node.

At operation 3235, responsive to receiving a second ACK frame corresponding to the relayed data frame from the destination node, the relay node relays the second ACK frame to the source node.

In an embodiment, the source node is a source AP, the relay node is a target AP, and the destination node is a non-AP STA that roams from the source AP to the target AP.

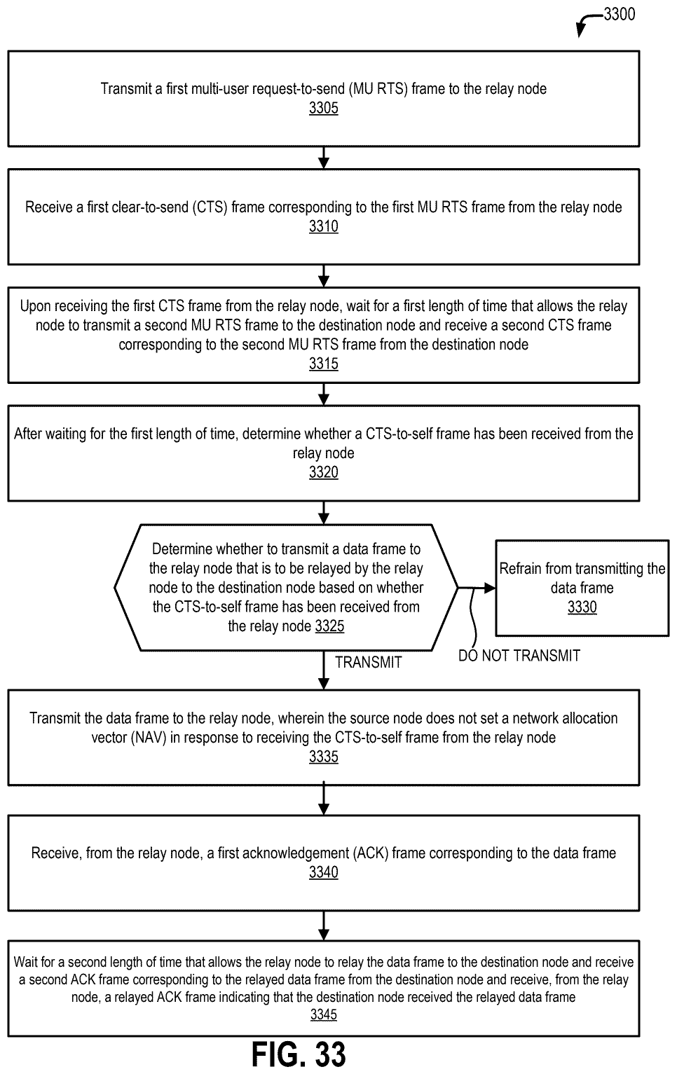

Turning now to FIG. 33, a method 3300 will be described for a source node to transmit data to a destination node via a relay node based on Technique 1 Method 2, in accordance with an example embodiment. The method 3300 may be performed by a source node. The source node may be a wireless device (e.g., wireless device 104).

At operation 3305, the source node transmits a first MURTS frame to the relay node.

At operation 3310, the source node receives a first CTS) frame corresponding to the first MU RTS frame from the relay node.

At operation 3315, upon receiving the first CTS frame from the relay node, the source node waits for a first length of time that allows the relay node to transmit a second MU RTS frame to the destination node and receive a second CTS frame corresponding to the second MU RTS frame from the destination node.

At operation 3320, the source node after waiting for the first length of time, the source node determines whether a CTS-to-self frame has been received from the relay node.

At operation 3325, the source node determines whether to transmit a data frame to the relay node that is to be relayed by the relay node to the destination node based on whether the CTS-to-self frame has been received from the relay node. For example, the source node may determine to transmit the data frame if the source node received the CTS-to-self frame from the relay node, but determine not to transmit the data frame if the source does not receive the CTS-to-self frame from the relay node. If the source node determines not to transmit the data frame, the method may proceed to operation 3330. At operation 3330, the source node refrains from transmitting the data frame to the relay node. If the source node determines to transmit the data frame, the method may proceed to operation 3335. At operation 3335, the source node transmits the data frame to the relay node, wherein the source node does not set a NAV in response to receiving the CTS-to-self frame from the relay node.

At operation 3340, the source node receives, from the relay node, a first ACK frame corresponding to the data frame.

At operation 3345, upon receiving the first ACK frame from the relay node, the source node waits for a second length of time that allows the relay node to relay the data frame to the destination node and receive a second ACK frame corresponding to the relayed data frame from the destination node, and after waiting for the second length of time, receives, from the relay node, a relayed ACK frame indicating that the destination node received the relayed data frame.

In an embodiment, the source node is a source AP, the relay node is a target AP, and the destination node is a non-AP STA that roams from the source AP to the target AP.

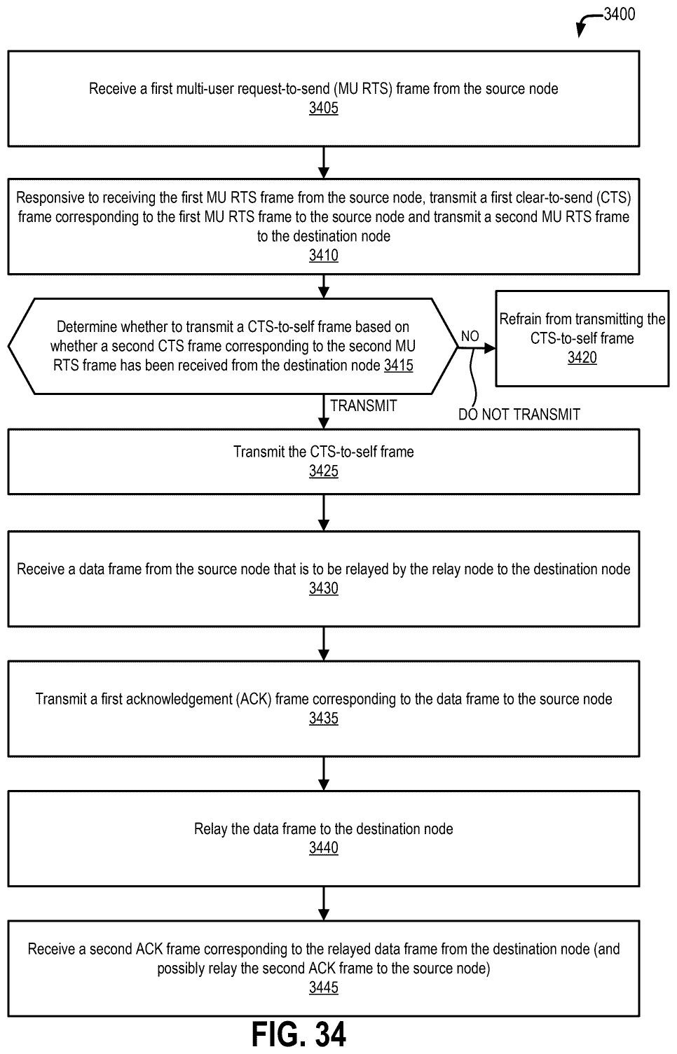

Turning now to FIG. 34, a method 3400 will be described for a relay node to relay data transmitted by a source node to a destination node based on Technique 1 Method 2, in accordance with an example embodiment. The method 3400 may be performed by a relay node. The relay node may be a wireless device (e.g., wireless device 104).

At operation 3405, the relay node receives a first MU RTS frame from the source node.

At operation 3410, responsive to receiving the first MU RTS frame from the source node, the relay node transmits a first CTS frame corresponding to the first MU RTS frame to the source node and transmits a second MU RTS frame to the destination node.

At operation 3415, the relay node determines whether to transmit a CTS-to-self frame based on whether a second CTS frame corresponding to the second MU RTS frame has been received from the destination node. For example, the relay node may determine to transmit the CTS-to-self frame if the relay node receives the second CTS frame, but determine not to transmit the CTS-to-self frame if the relay node does not receive the second CTS frame. If the relay node determines not to transmit the CTS-to-self frame, the method may proceed to operation 3420. At operation 3420, the relay node refrains from transmitting the CTS-to-self frame. If the relay node determines to transmit the CTS-to-self frame, the method may proceed to operation 3425. At operation 3425, the relay node transmits the CTS-to-self frame.

At operation 3430, the relay node receives a data frame from the source node that is to be relayed by the relay node to the destination node.

At operation 3435, the relay node transmits a first ACK frame corresponding to the data frame to the source node.

At operation 3440, the relay node relays the data frame to the destination node.

At operation 3445, the relay node receives a second ACK frame corresponding to the relayed data frame from the destination node.

In an embodiment, the source node is a source AP, the relay node is a target AP, and the destination node is a non-AP STA that roams from the source AP to the target AP.

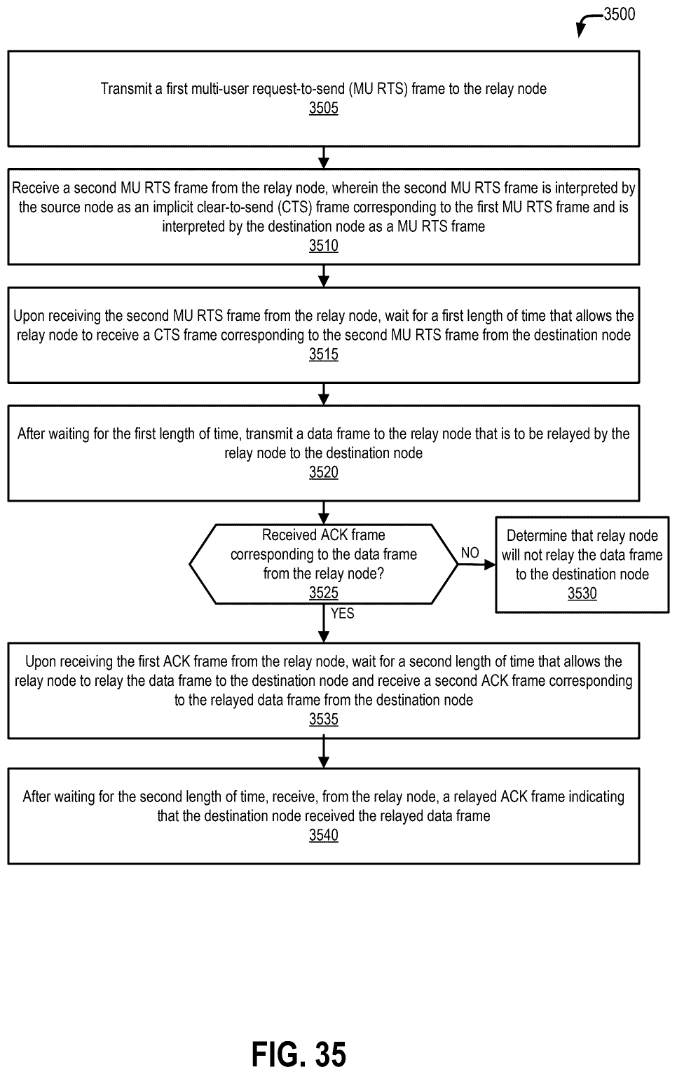

Turning now to FIG. 35, a method 3500 will be described for a source node to transmit data to a destination node via a relay node based on Technique 1 Method 3, in accordance with an example embodiment. The method 3500 may be performed by a source node. The source node may be a wireless device (e.g., wireless device 104).

At operation 3505, the source node transmits a first MU RTS frame to the relay node. In an embodiment, the first MU RTS frame includes a common info field, wherein the common info field includes a presence of relayed user info field that indicates that a relayed user info field is present in the MU RTS frame. In an embodiment, the first MU RTS frame includes a user info field, wherein the user info field includes an AID field that indicates a value that is within an extended range of AID values. In an embodiment, the first MU RTS frame includes a RA field that indicates an address of the relay node. In an embodiment, the first MU RTS frame includes a first user info field for the destination node and a second user info field for the relay node, wherein the first user info field includes a first RU allocation field that indicates a first value that is within an extended range of RU values, wherein the second user info field includes a second resource unit RU allocation field that indicates a second value that is within a non-extended range of RU values.

At operation 3510, the source node receives a second MU RTS frame from the relay node, wherein the second MU RTS frame is interpreted by the source node as an implicit CTS frame corresponding to the first MU RTS frame and is interpreted by the destination node as a MU RTS frame.

At operation 3515, upon receiving the second MU RTS frame from the relay node, the source node waits for a first length of time that allows the relay node to receive a CTS frame corresponding to the second MU RTS frame from the destination node.

At operation 3520, after waiting for the first length of time, the source node transmits a data frame to the relay node that is to be relayed by the relay node to the destination node.

At operation 3525, the source node determines whether it received an ACK frame corresponding to the data frame from the relay node. If the source node does not receive the ACK frame, the method may proceed to operation 3530. At operation 3530, the source node determines that the relay node will not relay the data frame to the destination node. If the source node receive the ACK frame, the method may proceed to operation 3535. At operation 3535, upon receiving the first ACK frame from the relay node, the source node waits for a second length of time that allows the relay node to relay the data frame to the destination node and receive a second ACK frame corresponding to the relayed data frame from the destination node.

At operation 3540, after waiting for the second length of time, the source node receives, from the relay node, a relayed ACK frame indicating that the destination node received the relayed data frame.

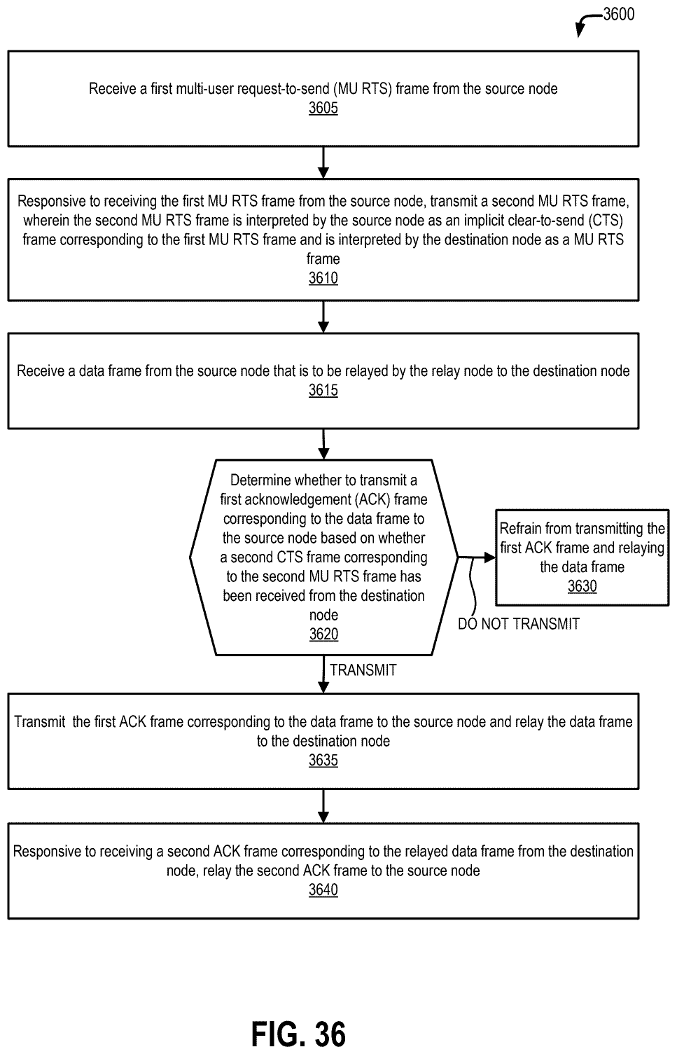

Turning now to FIG. 36, a method 3600 will be described for a relay node to relay data transmitted by a source node to a destination node based on Technique 1 Method 3, in accordance with an example embodiment. The method 3600 may be performed by a relay node. The relay node may be a wireless device (e.g., wireless device 104).

At operation 3605, the relay node receives a first MU RTS frame from the source node.

At operation 3610, responsive to receiving the first MU RTS frame from the source node, the relay node transmits a second MU RTS frame, wherein the second MU RTS frame is interpreted by the source node as an implicit CTS frame corresponding to the first MU RTS frame and is interpreted by the destination node as a MU RTS frame.

In an embodiment, the first MU RTS frame includes a common info field, wherein the common info field includes a presence of relayed user info field. In an embodiment, responsive to determining that the presence of relayed user info field indicates that a relayed user info field is present in the first MU RTS frame, the relay node may determine to transmit the second MU RTS frame instead of a CTS frame. In an embodiment, the relay node extracts values indicated by a relayed user info field included in the first MU RTS frame and sets a user info filed included in the second MU RTS frame to indicate the values.

In an embodiment, the first MU RTS frame includes one or more user info fields, wherein each of the one or more user info fields includes an AID field. In an embodiment, responsive to determining that the AID field included in at least one of the one or more user info fields indicates a value that is within an extended range of AID values, the relay node determines to transmit the second MU RTS frame instead of a CTS frame. In an embodiment, the relay node extracts a first value indicated by an AID field included in a user info field included in the first MU RTS frame, computes a second value by subtracting a predefined value from the first value, and sets an AID field included in a user info field included in the second MU RTS frame to indicate the second value.

In an embodiment, the first MU RTS frame includes a RA field. In an embodiment, responsive to determining that the RA field indicates an address of the relay node, the relay node determines to transmit the second MU RTS frame instead of a CTS frame.

In an embodiment, the first MU RTS frame includes a first user info field for the destination node and a second user info field for the relay node, wherein the first user info field includes a resource unit (RU) allocation field, wherein the first MU RTS frame includes 2*L user info fields. In an embodiment, responsive to determining that the RU allocation field indicates a value that is within an extended range of RU values and the second user info field exists in a first L user info fields included in the first MU RTS frame, the relay node determines to transmit the second MU RTS frame instead of a CTS frame. In an embodiment, the relay node extracts a value indicated by a RU allocation field included in a l-th user info field included in the first MU RTS frame, sets a RU allocation field included in a l-th user info field included in the second MU RTS frame to indicate the value, extracts values indicated by a L+l-th user info included in the first MU RTS frame wherein the values are not indicated by a RU allocation field included in the L+l-th user info field, and sets fields included in the l-th user info field included in the second MU RTS frame to indicate the values.

At operation 3615, the relay node receives a data frame from the source node that is to be relayed by the relay node to the destination node.

At operation 3620, the relay node determines whether to transmit a first ACK frame corresponding to the data frame to the source node based on whether a CTS frame corresponding to the second MU RTS frame has been received from the destination node. For example, the relay node may determine to transmit the first ACK frame if the relay node receives the second CTS frame from the destination node, but may determine not to transmit the first ACK frame if the relay node does not receive the second CTS frame from the destination node. If the relay node determines not to transmit the first ACK frame, the method proceeds to operation 3630. At operation 3630, the relay node refrains from transmitting the first ACK frame corresponding to the data frame to the source node and refrains from relaying the data frame to the destination node. If the relay node determines to transmit the first ACK frame, the method proceeds to operation 3635. At operation 3635, the relay node transmits the first ACK frame corresponding to the data frame to the source node and relays the data frame to the destination node.

At operation 3640, responsive to receiving a second ACK frame corresponding to the relayed data frame from the destination node, the relay node relays the second ACK frame to the source node the relay node.

In an embodiment, the source node is a source AP, the relay node is a target AP, and the destination node is a non-AP STA that roams from the source AP to the target AP.

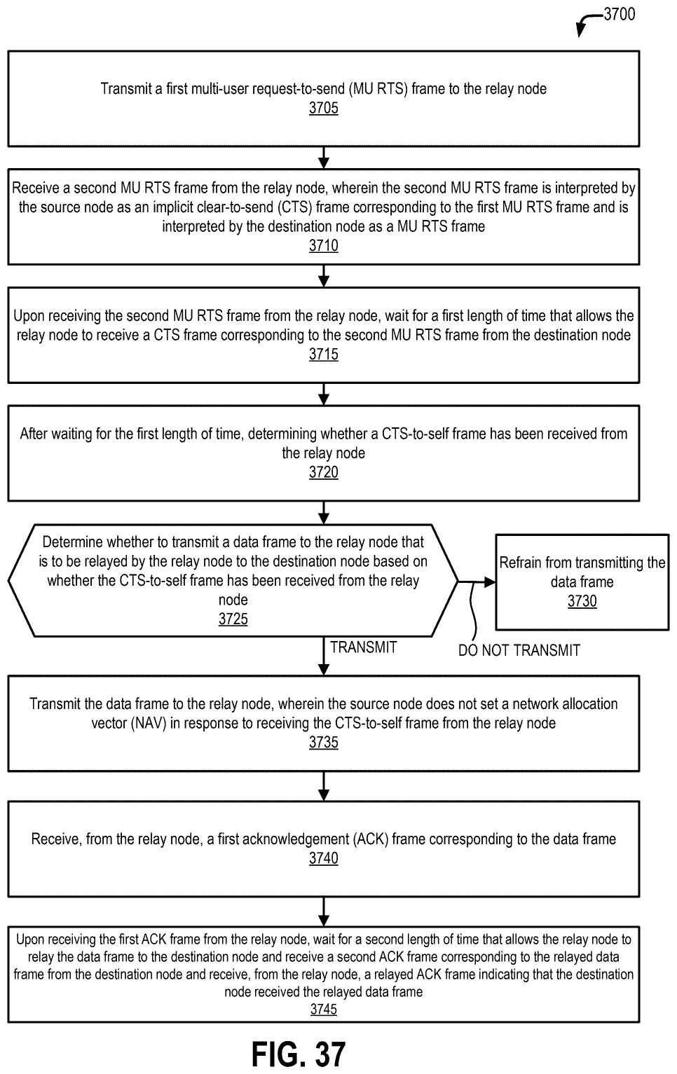

Turning now to FIG. 37, a method 3700 will be described for a source node to transmit data to a destination node via a relay node based on Technique 1 Method 4, in accordance with an example embodiment. The method 3700 may be performed by a source node. The source node may be a wireless device (e.g., wireless device 104).

At operation 3705, the source node transmits a first MU RTS frame to the relay node. In an embodiment, the first MU RTS frame includes a common info field, wherein the common info field includes a presence of relayed user info field that indicates that a relayed user info field is present in the MU RTS frame. In an embodiment, the first MU RTS frame includes a user info field, wherein the user info field includes an AID field that indicates a value that is within an extended range of AID values. In an embodiment, the first MU RTS frame includes a RA field that indicates an address of the relay node. In an embodiment, the first MU RTS frame includes a first user info field for the destination node and a second user info field for the relay node, wherein the first user info field includes a first RU allocation field that indicates a first value that is within an extended range of RU values, wherein the second user info field includes a second resource unit RU allocation field that indicates a second value that is within a non-extended range of RU values.

At operation 3710, the source node receives a second MU RTS frame from the relay node, wherein the second MU RTS frame is interpreted by the source node as an implicit CTS frame corresponding to the first MU RTS frame and is interpreted by the destination node as a MU RTS frame.

At operation 3715, upon receiving the second MU RTS frame from the relay node, the source node waits for a first length of time that allows the relay node to receive a CTS frame corresponding to the second MU RTS frame from the destination node.

At operation 3720, after waiting for the first length of time, the source node determines whether a CTS-to-self frame has been received from the relay node.

At operation 3725, the source node determines whether to transmit a data frame to the relay node that is to be relayed by the relay node to the destination node based on whether the CTS-to-self frame has been received from the relay node. For example, the source node may determine to transmit the data frame if the source node received the CTS-to-self frame from the relay node, but determine not to transmit the data frame if the source does not receive the CTS-to-self frame from the relay node. If the source node determines not to transmit the data frame, the method may proceed to operation 3730. At operation 3730, the source node refrains from transmitting the data frame to the relay node. If the source node determines to transmit the data frame, the method may proceed to operation 3735. At operation 3735, the source node transmits the data frame to the relay node, wherein the source node does not set a NAV in response to receiving the CTS-to-self frame from the relay node.

At operation 3740, the source node receives, from the relay node, a first ACK frame corresponding to the data frame.

At operation 3745, upon receiving the first ACK frame from the relay node, the source node waits for a second length of time that allows the relay node to relay the data frame to the destination node and receive a second ACK frame corresponding to the relayed data frame from the destination node, and after waiting for the second length of time, receives, from the relay node, a relayed ACK frame indicating that the destination node received the relayed data frame.

In an embodiment, the source node is a source AP, the relay node is a target AP, and the destination node is a non-AP STA that roams from the source AP to the target AP.

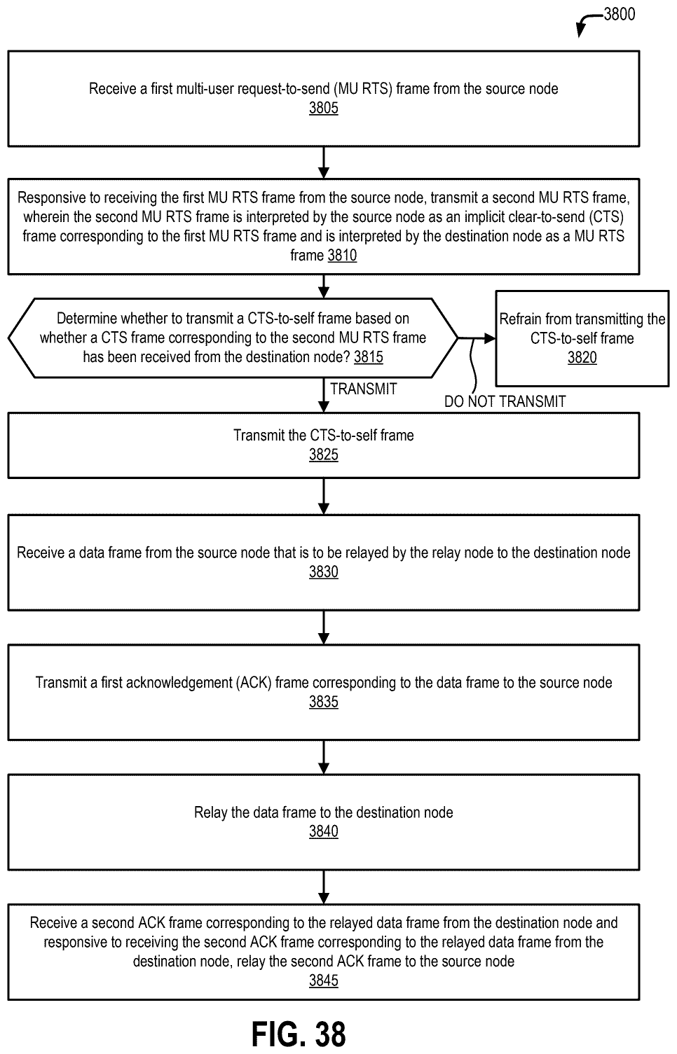

Turning now to FIG. 38, a method 3800 will be described for a relay node to relay data transmitted by a source node to a destination node based on Technique 1 Method 4, in accordance with an example embodiment. The method 3800 may be performed by a relay node. The relay node may be a wireless device (e.g., wireless device 104).

At operation 3805, the relay node receives a first MU RTS frame from the source node.

At operation 3810, responsive to receiving the first MU RTS frame from the source node, the relay node transmits a second MU RTS frame, wherein the second MU RTS frame is interpreted by the source node as an implicit CTS frame corresponding to the first MU RTS frame and is interpreted by the destination node as a MU RTS frame.

In an embodiment, the first MU RTS frame includes a common info field, wherein the common info field includes a presence of relayed user info field. In an embodiment, responsive to determining that the presence of relayed user info field indicates that a relayed user info field is present in the first MU RTS frame, the relay node may determine to transmit the second MU RTS frame instead of a CTS frame. In an embodiment, the relay node extracts values indicated by a relayed user info field included in the first MU RTS frame and sets a user info filed included in the second MU RTS frame to indicate the values.

In an embodiment, the first MU RTS frame includes one or more user info fields, wherein each of the one or more user info fields includes an AID field. In an embodiment, responsive to determining that the AID field included in at least one of the one or more user info fields indicates a value that is within an extended range of AID values, the relay node determines to transmit the second MU RTS frame instead of a CTS frame. In an embodiment, the relay node extracts a first value indicated by an AID field included in a user info field included in the first MU RTS frame, computes a second value by subtracting a predefined value from the first value, and sets an AID field included in a user info field included in the second MU RTS frame to indicate the second value.

In an embodiment, the first MU RTS frame includes a RA field. In an embodiment, responsive to determining that the RA field indicates an address of the relay node, the relay node determines to transmit the second MU RTS frame instead of a CTS frame.

In an embodiment, the first MU RTS frame includes a first user info field for the destination node and a second user info field for the relay node, wherein the first user info field includes a resource unit (RU) allocation field, wherein the first MU RTS frame includes 2*L user info fields. In an embodiment, responsive to determining that the RU allocation field indicates a value that is within an extended range of RU values and the second user info field exists in a first L user info fields included in the first MU RTS frame, the relay node determines to transmit the second MU RTS frame instead of a CTS frame. In an embodiment, the relay node extracts a value indicated by a RU allocation field included in a l-th user info field included in the first MU RTS frame, sets a RU allocation field included in a l-th user info field included in the second MU RTS frame to indicate the value, extracts values indicated by a L+l-th user info included in the first MU RTS frame wherein the values are not indicated by a RU allocation field included in the L+l-th user info field, and sets fields included in the l-th user info field included in the second MU RTS frame to indicate the values.

At operation 3815, the relay node determines whether to transmit a CTS-to-self frame based on whether a CTS frame corresponding to the second MU RTS frame has been received from the destination node. For example, the relay node may determine to transmit the CTS-to-self frame if the relay node receives the second CTS frame, but determine not to transmit the CTS-to-self frame if the relay node does not receive the second CTS frame. If the relay node determines not to transmit the CTS-to-self frame, the method may proceed to operation 3820. At operation 3820, the relay node refrains from transmitting the CTS-to-self frame. If the relay node determines to transmit the CTS-to-self frame, the method may proceed to operation 3825. At operation 3825, the relay node transmits the CTS-to-self frame.

At operation 3830, the relay node receives a data frame from the source node that is to be relayed by the relay node to the destination node.

At operation 3835, the relay node transmits a first ACK frame corresponding to the data frame to the source node.

At operation 3840, the relay node relays the data frame to the destination node.

At operation 3845, the relay node receives a second ACK frame corresponding to the relayed data frame from the destination node, and responsive to receiving the second ACK frame corresponding to the relayed data frame from the destination node, relays the second ACK frame to the source node.

In an embodiment, the source node is a source AP, the relay node is a target AP, and the destination node is a non-AP STA that roams from the source AP to the target AP.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a source node to transmit data to a destination node via a relay node, the method comprising:
transmitting a first multi-user request-to-send (MU RTS) frame to the relay node;
receiving a first clear-to-send (CTS) frame corresponding to the first MU RTS frame from the relay node;
upon receiving the first CTS frame from the relay node, waiting for a first length of time that allows the relay node to transmit a second MU RTS frame to the destination node and receive a second CTS frame corresponding to the second MU RTS frame from the destination node; and
after waiting for the first length of time, transmitting a data frame to the relay node that is to be relayed by the relay node to the destination node.

2. The method of claim 1, further comprising:
receiving, from the relay node, a first acknowledgment (ACK) frame corresponding to the data frame.

3. The method of claim 2, further comprising:
upon receiving the first ACK frame from the relay node, waiting for a second length of time that allows the relay node to relay the data frame to the destination node and receive a second ACK frame corresponding to the relayed data frame from the destination node; and
after waiting for the second length of time, receiving, from the relay node, a relayed ACK frame indicating that the destination node received the relayed data frame.

4. The method of claim 1, further comprising:
determining that the relay node will not relay the data frame to the destination node based on not receiving an ACK frame corresponding to the data frame from relay node.

5. The method of claim 1, wherein the source node is a source access point (AP), the relay node is a target AP, and the destination node is a non-AP station (STA) that roams from the source AP to the target AP.

6. A method performed by a relay node to relay data transmitted by a source node to a destination node, the method comprising:
receiving a first multi-user request-to-send (MU RTS) frame from the source node;
responsive to receiving the first MU RTS frame from the source node, transmitting a first clear-to-send (CTS) frame corresponding to the first MU RTS frame to the source node and transmitting a second MU RTS frame to the destination node;
receiving a data frame from the source node that is to be relayed by the relay node to the destination node; and
determining whether to transmit a first acknowledgement (ACK) frame corresponding to the data frame to the source node based on whether a second CTS frame corresponding to the second MU RTS frame has been received from the destination node.

7. The method of claim 6, further comprising:
responsive to determining that the first ACK frame corresponding to the data frame is to be transmitted to the source node, transmitting the first ACK frame corresponding to the data frame to the source node and relaying the data frame to the destination node.

8. The method of claim 7, further comprising:
responsive to receiving a second ACK frame corresponding to the relayed data frame from the destination node, relaying the second ACK frame to the source node.

9. The method of claim 6, further comprising:
responsive to determining that the first ACK frame corresponding to the data frame is not to be transmitted to the source node, refraining from transmitting the first ACK frame corresponding to the data frame to the source node and refraining from relaying the data frame to the destination node.

10. The method of claim 6, wherein the source node is a source access point (AP), the relay node is a target AP, and the destination node is a non-AP station (STA) that roams from the source AP to the target AP.

11. A method performed by a source node to transmit data to a destination node via a relay node, the method comprising:
transmitting a first multi-user request-to-send (MU RTS) frame to the relay node;
receiving a first clear-to-send (CTS) frame corresponding to the first MU RTS frame from the relay node;
upon receiving the first CTS frame from the relay node, waiting for a first length of time that allows the relay node to transmit a second MU RTS frame to the destination node and receive a second CTS frame corresponding to the second MU RTS frame from the destination node;
after waiting for the first length of time, determining whether a CTS-to-self frame has been received from the relay node; and
determining whether to transmit a data frame to the relay node that is to be relayed by the relay node to the destination node based on whether the CTS-to-self frame has been received from the relay node.

12. The method of claim 11, further comprising:
responsive to determining that the data frame is to be transmitted to the relay node, transmitting the data frame to the relay node, wherein the source node does not set a network allocation vector (NAV) in response to receiving the CTS-to-self frame from the relay node.

13. The method of claim 12, further comprising:
receiving, from the relay node, a first acknowledgement (ACK) frame corresponding to the data frame.

14. The method of claim 13, further comprising:
upon receiving the first ACK frame from the relay node, waiting for a second length of time that allows the relay node to relay the data frame to the destination node and receive a second ACK frame corresponding to the relayed data frame from the destination node; and
after waiting for the second length of time, receiving, from the relay node, a relayed ACK frame indicating that the destination node received the relayed data frame.

15. The method of claim 11, further comprising:
responsive to determining that the data frame is not to be transmitted to the relay node, refraining from transmitting the data frame to the relay node.

16. The method of claim 11, wherein the source node is a source access point (AP), the relay node is a target AP, and the destination node is a non-AP station (STA) that roams from the source AP to the target AP.

17. A method performed by a relay node to relay data transmitted by a source node to a destination node, the method comprising:
receiving a first multi-user request-to-send (MU RTS) frame from the source node;
responsive to receiving the first MU RTS frame from the source node, transmitting a first clear-to-send (CTS) frame corresponding to the first MU RTS frame to the source node and transmitting a second MU RTS frame to the destination node; and
determining whether to transmit a CTS-to-self frame based on whether a second CTS frame corresponding to the second MU RTS frame has been received from the destination node.

18. The method of claim 17, further comprising:
responsive to determining that the CTS-to-self frame is to be transmitted, transmitting the CTS-to-self frame;
receiving a data frame from the source node that is to be relayed by the relay node to the destination node;
transmitting a first acknowledgement (ACK) frame corresponding to the data frame to the source node;
relaying the data frame to the destination node; and
receiving a second ACK frame corresponding to the relayed data frame from the destination node.

19. The method of claim 18, further comprising:
responsive to receiving the second ACK frame corresponding to the relayed data frame from the destination node, relaying the second ACK frame to the source node.

20. The method of claim 17, further comprising:
responsive to determining that the CTS-to-self frame is not to be transmitted, refraining from transmitting the CTS-to-self frame.

21. The method of claim 17, wherein the source node is a source access point (AP), the relay node is a target AP, and the destination node is a non-AP station (STA) that roams from the source AP to the target AP.

22. A method performed by a source node to transmit data to a destination node via a relay node, the method comprising:
transmitting a first multi-user request-to-send (MU RTS) frame to the relay node;
receiving a second MU RTS frame from the relay node, wherein the second MU RTS frame is interpreted by the source node as an implicit clear-to-send (CTS) frame corresponding to the first MU RTS frame and is interpreted by the destination node as a MU RTS frame;
upon receiving the second MU RTS frame from the relay node, waiting for a first length of time that allows the relay node to receive a CTS frame corresponding to the second MU RTS frame from the destination node; and
after waiting for the first length of time, transmitting a data frame to the relay node that is to be relayed by the relay node to the destination node.

23. The method of claim 22, further comprising:
receiving, from the relay node, a first acknowledgement (ACK) frame corresponding to the data frame.

24. The method of claim 23, further comprising:
upon receiving the first ACK frame from the relay node, waiting for a second length of time that allows the relay node to relay the data frame to the destination node and receive a second ACK frame corresponding to the relayed data frame from the destination node; and
after waiting for the second length of time, receiving, from the relay node, a relayed ACK frame indicating that the destination node received the relayed data frame.

25. The method of claim 22, further comprising:
determining that the relay node will not relay the data frame to the destination node based on not receiving an ACK frame corresponding to the data frame from relay node.

26. The method of claim 22, wherein the first MU RTS frame includes a common info field, wherein the common info field includes a presence of relayed user info field that indicates that a relayed user info field is present in the MU RTS frame.

27. The method of claim 22, wherein the first MU RTS frame includes a user info field, wherein the user info field includes an association identifier (AID) field that indicates a value that is within an extended range of AID values.

28. The method of claim 22, wherein the first MU RTS frame includes a receiver address (RA) field that indicates an address of the relay node.

29. The method of claim 22, wherein the first MU RTS frame includes a first user info field for the destination node and a second user info field for the relay node, wherein the first user info field includes a first resource unit (RU) allocation field that indicates a first value that is within an extended range of RU values, wherein the second user info field includes a second resource unit RU allocation field that indicates a second value that is within a non-extended range of RU values.

30. The method of claim 22, wherein the source node is a source access point (AP), the relay node is a target AP, and the destination node is a non-AP station (STA) that roams from the source AP to the target AP.

31. A method performed by a relay node to relay data transmitted by a source node to a destination node, the method comprising:
receiving a first multi-user request-to-send (MU RTS) frame from the source node;
responsive to receiving the first MU RTS frame from the source node, transmitting a second MU RTS frame, wherein the second MU RTS frame is interpreted by the source node as an implicit clear-to-send (CTS) frame corresponding to the first MU RTS frame and is interpreted by the destination node as a MU RTS frame;
receiving a data frame from the source node that is to be relayed by the relay node to the destination node; and
determining whether to transmit a first acknowledgement (ACK) frame corresponding to the data frame to the source node based on whether a CTS frame corresponding to the second MU RTS frame has been received from the destination node.

32. The method of claim 31, further comprising:
responsive to determining that the first ACK frame corresponding to the data frame is to be transmitted to the source node, transmitting the first ACK frame corresponding to the data frame to the source node and relaying the data frame to the destination node.

33. The method of claim 32, further comprising:
responsive to receiving a second ACK frame corresponding to the relayed data frame from the destination node, relaying the second ACK frame to the source node.

34. The method of claim 31, further comprising:
responsive to determining that the first ACK frame corresponding to the data frame is not to be transmitted to the source node, refraining from transmitting the first ACK frame corresponding to the data frame to the source node and refraining from relaying the data frame to the destination node.

35. The method of claim 31, wherein the first MU RTS frame includes a common info field, wherein the common info field includes a presence of relayed user info field, the method further comprising:
responsive to determining that the presence of relayed user info field indicates that a relayed user info field is present in the first MU RTS frame, determining to transmit the second MU RTS frame instead of a CTS frame.

36. The method of claim 35, further comprising:
extracting values indicated by a relayed user info field included in the first MU RTS frame; and
setting a user info filed included in the second MU RTS frame to indicate the values.

37. The method of claim 31, wherein the first MU RTS frame includes one or more user info fields, wherein each of the one or more user info fields includes an association identifier (AID) field, the method further comprising:
responsive to determining that the AID field included in at least one of the one or more user info fields indicates a value that is within an extended range of AID values, determining to transmit the second MU RTS frame instead of a CTS frame.

38. The method of claim 37, further comprising:
extracting a first value indicated by an AID field included in a user info field included in the first MU RTS frame;
computing a second value by subtracting a predefined value from the first value; and
setting an AID field included in a user info field included in the second MU RTS frame to indicate the second value.

39. The method of claim 31, wherein the first MU RTS frame includes a receiver address (RA) field, the method further comprising:
responsive to determining that the RA field indicates an address of the relay node, determining to transmit the second MU RTS frame instead of a CTS frame.

40. The method of claim 31, wherein the first MU RTS frame includes a first user info field for the destination node and a second user info field for the relay node, wherein the first user info field includes a resource unit (RU) allocation field, wherein the first MU RTS frame includes 2*L user info fields, the method further comprising:
responsive to determining that the RU allocation field indicates a value that is within an extended range of RU values and the second user info field exists in a first L user info fields included in the first MU RTS frame, determining to transmit the second MU RTS frame instead of a CTS frame.

41. The method of claim 40, further comprising:
extracting a value indicated by a RU allocation field included in a l-th user info field included in the first MU RTS frame;
setting a RU allocation field included in a l-th user info field included in the second MU RTS frame to indicate the value;
extracting values indicated by a L+l-th user info included in the first MU RTS frame wherein the values are not indicated by a RU allocation field included in the L+l-th user info field; and
setting fields included in the l-th user info field included in the second MU RTS frame to indicate the values.

42. The method of claim 31, wherein the source node is a source access point (AP), the relay node is a target AP, and the destination node is a non-AP station (STA) that roams from the source AP to the target AP.

43. A method performed by a source node to transmit data to a destination node via a relay node, the method comprising:
transmitting a first multi-user request-to-send (MU RTS) frame to the relay node;
receiving a second MU RTS frame from the relay node, wherein the second MU RTS frame is interpreted by the source node as an implicit clear-to-send (CTS) frame corresponding to the first MU RTS frame and is interpreted by the destination node as a MU RTS frame;
upon receiving the second MU RTS frame from the relay node, waiting for a first length of time that allows the relay node to receive a CTS frame corresponding to the second MU RTS frame from the destination node;
after waiting for the first length of time, determining whether a CTS-to-self frame has been received from the relay node; and
determining whether to transmit a data frame to the relay node that is to be relayed by the relay node to the destination node based on whether the CTS-to-self frame has been received from the relay node.

44. The method of claim 43, further comprising:
responsive to determining that the data frame is to be transmitted to the relay node, transmitting the data frame to the relay node, wherein the source node does not set a network allocation vector (NAV) in response to receiving the CTS-to-self frame from the relay node.

45. The method of claim 44, further comprising:
receiving, from the relay node, a first acknowledgement (ACK) frame corresponding to the data frame.

46. The method of claim 45, further comprising:
upon receiving the first ACK frame from the relay node, waiting for a second length of time that allows the relay node to relay the data frame to the destination node and receive a second ACK frame corresponding to the relayed data frame from the destination node; and
after waiting for the second length of time, receiving, from the relay node, a relayed ACK frame indicating that the destination node received the relayed data frame.

47. The method of claim 43, further comprising:
responsive to determining that the data frame is not to be transmitted to the relay node, refraining from transmitting the data frame to the relay node.

48. The method of claim 43, wherein the first MU RTS frame includes a common info field, wherein the common info field includes a presence of relayed user info field that indicates that a relayed user info field is present in the MU RTS frame.

49. The method of claim 43, wherein the first MU RTS frame includes a user info field, wherein the user info field includes an association identifier (AID) field that indicates a value that is within an extended range of AID values.

50. The method of claim 43, wherein the first MU RTS frame includes a receiver address (RA) field that indicates an address of the relay node.

51. The method of claim 43, wherein the first MU RTS frame includes a first user info field for the destination node and a second user info field for the relay node, wherein the first user info field includes a first resource unit (RU) allocation field that indicates a first value that is within an extended range of RU values, wherein the second user info field includes a second resource unit RU allocation field that indicates a second value that is within a non-extended range of RU values.

52. The method of claim 43, wherein the source node is a source access point (AP), the relay node is a target AP, and the destination node is a non-AP station (STA) that roams from the source AP to the target AP.

53. A method performed by a relay node to relay data transmitted by a source node to a destination node, the method comprising:
receiving a first multi-user request-to-send (MU RTS) frame from the source node;
responsive to receiving the first MU RTS frame from the source node, transmitting a second MU RTS frame, wherein the second MU RTS frame is interpreted by the source node as an implicit clear-to-send (CTS) frame corresponding to the first MU RTS frame and is interpreted by the destination node as a MU RTS frame; and
determining whether to transmit a CTS-to-self frame based on whether a CTS frame corresponding to the second MU RTS frame has been received from the destination node.

54. The method of claim 53, further comprising:
responsive to determining that the CTS-to-self frame is to be transmitted, transmitting the CTS-to-self frame;
receiving a data frame from the source node that is to be relayed by the relay node to the destination node;
transmitting a first acknowledgement (ACK) frame corresponding to the data frame to the source node;
relaying the data frame to the destination node; and
receiving a second ACK frame corresponding to the relayed data frame from the destination node.

55. The method of claim 54, further comprising:
responsive to receiving the second ACK frame corresponding to the relayed data frame from the destination node, relaying the second ACK frame to the source node.

56. The method of claim 53, further comprising:
responsive to determining that the CTS-to-self frame is not to be transmitted, refraining from transmitting the CTS-to-self frame.

57. The method of claim 53, wherein the first MU RTS frame includes a common info field, wherein the common info field includes a presence of relayed user info field, the method further comprising:
responsive to determining that the presence of relayed user info field indicates that a relayed user info field is present in the first MU RTS frame, determining to transmit the second MU RTS frame instead of a CTS frame.

58. The method of claim 57, further comprising:
extracting values indicated by a relayed user info field included in the first MU RTS frame; and
setting a user info filed included in the second MU RTS frame to indicate the values.

59. The method of claim 53, wherein the first MU RTS frame includes one or more user info fields, wherein each of the one or more user info fields includes an association identifier (AID) field, the method further comprising:
responsive to determining that the AID field included in at least one of the one or more user info fields indicates a value that is within an extended range of AID values, determining to transmit the second MU RTS frame instead of a CTS frame.

60. The method of claim 59, further comprising:
extracting a first value indicated by an AID field included in a user info field included in the first MU RTS frame;
computing a second value by subtracting a predefined value from the first value; and
setting an AID field included in a user info field included in the second MU RTS frame to indicate the second value.

61. The method of claim 53, wherein the first MU RTS frame includes a receiver address (RA) field, the method further comprising:
responsive to determining that the RA field indicates an address of the relay node, determining to transmit the second MU RTS frame instead of a CTS frame.

62. The method of claim 53, wherein the first MU RTS frame includes a first user info field for the destination node and a second user info field for the relay node, wherein the first user info field includes a resource unit (RU) allocation field, wherein the first MU RTS frame includes 2*L user info fields, the method further comprising:
responsive to determining that the RU allocation field indicates a value that is within an extended range of RU values and the second user info field exists in a first Z user info fields included in the first MU RTS frame, determining to transmit the second MU RTS frame instead of a CTS frame.

63. The method of claim 62, further comprising:
extracting a value indicated by a RU allocation field included in a l-th user info field included in the first MU RTS frame;
setting a RU allocation field included in a l-th user info field included in the second MU RTS frame to indicate the value;
extracting values indicated by a L+l-th user info included in the first MU RTS frame wherein the values are not indicated by a RU allocation field included in the L+l-th user info field; and
setting fields included in the l-th user info field included in the second MU RTS frame to indicate the values.

64. The method of claim 53, wherein the source node is a source access point (AP), the relay node is a target AP, and the destination node is a non-AP station (STA) that roams from the source AP to the target AP.
